(19) United States
(12) Patent Application Publication
(10) Pub. No.: US 2024/0010216 A1
(43) Pub. Date: Jan. 11, 2024

(54) AUTOMATED DRIVING CONTROL DEVICE, NON-TRANSITORY COMPUTER-READABLE STORAGE MEDIUM STORING AUTOMATED DRIVING CONTROL PROGRAM, PRESENTATION CONTROL DEVICE, AND NON-TRANSITORY COMPUTER-READABLE STORAGE MEDIUM STORING PRESENTATION CONTROL PROGRAM

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 18/471,130

(22) Filed: Sep. 20, 2023

Related U.S. Application Data
(63) Continuation of application No. PCT/JP2022/006835, filed on Feb. 21, 2022.

(30) Foreign Application Priority Data
Mar. 23, 2021 (JP) 2021-049204
Nov. 1, 2021 (JP) 2021-178901

(51) Int. Cl. B60W 50/12; B60W 60/00; B60W 40/08; B60W 50/14

(52) U.S. Cl. CPC B60W 50/12; B60W 60/0059; B60W 40/08; B60W 50/14; B60W 2040/0818; B60W 2040/0872; B60W 2050/143; B60W 2050/146; B60W 2540/221; B60W 2540/229; B60W 2552/53; B60W 2554/4041; B60W 2554/406; B60W 2554/801

(57) ABSTRACT

By an automate driving control device, a presentation control device, a non-transitory computer-readable storage medium storing an automated driving control device or a presentation control program, an offset control is executed and the execution is limited or, whether to execute the offset control is recognized and notification related to the offset control is performed.

### CROSS REFERENCE TO RELATED APPLICATIONS

The present application is a continuation application of International Patent Application No. PCT/JP2022/006835 filed on Feb. 21, 2022, which designated the U.S. and claims the benefit of priority from Japanese Patent Application No. 2021-049204 filed on Mar. 23, 2021 and the benefit of priority from Japanese Patent Application No. 2021-178901 filed on Nov. 1, 2021. The entire disclosures of all of the above applications are incorporated herein by reference.

### TECHNICAL FIELD

The present disclosure relates to an automated driving control device, a non-transitory computer-readable storage medium storing an automated driving control program, a presentation control device, and a non-transitory computer-readable storage medium storing a presentation control program.

### BACKGROUND

A travel control device of a comparative example performs offset control for offsetting a traveling position of a subject vehicle in a vehicle width direction so as to increase a distance between the subject vehicle and another vehicle traveling side by side. In the comparative example, second offset control in which an offset amount is reduced with respect to first offset control is preferentially performed at the time of traffic congestion following, traveling on a motorway, and autonomous driving at a high level with no periphery monitoring obligation by a driver, or the like.

### SUMMARY

By an automate driving control device, a presentation control device, a non-transitory computer-readable storage medium storing an automated driving control device or a presentation control program, an offset control is executed and the execution is limited or, whether to execute the offset control is recognized and notification related to the offset control is performed.

### BRIEF DESCRIPTION OF DRAWINGS

FIG. 1 is a diagram showing an overview of an in-vehicle network including an autonomous driving system and an HMI system according to a first embodiment of the present disclosure.

FIG. 2 is a block diagram showing details of an autonomous driving ECU.

FIG. 3 is a block diagram showing details of an HCU.

FIG. 4 is a diagram showing details of offset control.

FIG. 5 is a diagram showing details of the offset control.

FIG. 6 is a flowchart showing details of a control setting process for changing the setting of the offset control.

FIG. 7 is a diagram showing an example of a notification related to the offset control.

FIG. 8 is a flowchart showing details of a notification switching process for switching between issuing and non-issuing of an offset notification in a second embodiment of the present disclosure.

FIG. 9 is a flowchart showing details of a notification issuing process for issuing an offset notification.

FIG. 10 is a diagram showing an example of a notification related to the offset control.

### DETAILED DESCRIPTION

Movement in a lateral direction due to the offset control of the comparative example is likely to be troublesome for the driver who does not see the periphery of the subject vehicle particularly in a period of the autonomous driving with no periphery monitoring obligation. Therefore, when the offset amount is simply reduced as in the travel control device of the comparative example, there is a concern that the driver still feels troublesome about acceleration due to the offset control.

The present disclosure provides an automated driving control device, a non-transitory computer-readable storage medium storing an automated driving control program, a presentation control device, and a non-transitory computer-readable storage medium storing a presentation control program capable of improving convenience of autonomous driving with no periphery monitoring obligation by reducing troublesomeness about offset control.

According to one example of the present disclosure, an automated driving control device includes: a control switching unit configured to perform switching between a driving assistance control with a periphery monitoring obligation of a driver and an autonomous traveling control without the periphery monitoring obligation of the driver; and an offset control unit configured to execute an offset control that moves a reference position in a left direction or a right direction during a driving assistance period in which the subject vehicle travels with the driving assistance control, and limit execution of the offset control during an automated driving period in which the subject vehicle travels with the autonomous traveling control.

According to another example of the present disclosure, a non-transitory computer-readable storage medium stores an automated driving control program causing at least one processor to: execute an offset control that requires an periphery monitoring obligation of a driver and moves a traveling position of a subject vehicle in a left direction or a right direction with respect to a reference position during a driving assistance period in which the subject vehicle travels with the driving assistance control with a periphery monitoring obligation of the driver, and limit the execution of the offset control during an automated driving period in which the subject vehicle travels with the autonomous traveling control without the periphery monitoring obligation of the driver.

In these examples, the execution of the offset control is restricted in an autonomous driving period in which the subject vehicle travels under autonomous traveling control with no periphery monitoring obligation. Therefore, in a scene in which the driver does not see the periphery of the subject vehicle, an occurrence frequency of acceleration in the lateral direction that is troublesome for the driver can be reduced. As a result, the driver feels comfortable in the autonomous driving period, and thus the convenience of autonomous driving can be improved.

Further, according to another example, an automated driving control device is capable of performing automated driving without a periphery monitoring obligation of a driver, and the device includes: a lane recognition unit configured to recognize a subject vehicle lane in which a subject vehicle travels among a plurality of lanes when the subject vehicle travels by the automated driving on a road including the plurality of lanes; and an offset control unit configured to execute an offset control that moves a traveling position of a subject vehicle in a left direction or a right direction with respect to a reference position, and change content of the offset control according to a position of the subject vehicle lane among the plurality of lanes.

Further, according to another example, a non-transitory computer-readable storage medium stores an automated driving control program that is capable of performing automated driving without a periphery monitoring obligation of a driver and causes at least one processor to: recognize a subject vehicle lane in which a subject vehicle travels among a plurality of lanes when the subject vehicle travels by automated driving on a road including the plurality of lanes; recognize whether the subject vehicle lane is an edge lane that is an outermost lane of the road among the plurality of lanes; execute an offset control that moves a traveling position of a subject vehicle in a left direction or a right direction with respect to a reference position; and change content of the offset control according to a position of the subject vehicle lane among the plurality of lanes.

In these examples, contents of the offset control are changed according to a position of a subject vehicle lane on which the subject vehicle travels. Therefore, in a period in which the vehicle travels on a road including multiple lanes by autonomous driving, unnecessary movement in the lateral direction due to the offset control can be limited. As a result, the acceleration in the lateral direction that is likely to be troublesome for the driver is reduced, and thus the convenience of autonomous driving can be improved.

Further, according to another example, an automated driving control device is capable of performing automated driving without a periphery monitoring obligation of a driver, and the device includes: a different vehicle recognition unit configured to recognize a traveling position in a lateral direction in a subject vehicle lane in which the subject vehicle and a different vehicle travel; and an offset control unit configured to execute an offset control that moves a traveling position of the subject vehicle in a left direction or a right direction with respect to a reference position, and change content of the offset control according to a traveling position of the different vehicle in the subject vehicle lane.

Further, according to another example, a non-transitory computer-readable storage medium stores an automated driving control program that is capable pf performing automated driving without a periphery monitoring obligation of a driver and causes at least one processor to: execute an offset control that moves a traveling position of a subject vehicle in a left direction or a right direction with respect to a reference position; recognize a lateral traveling position of the different vehicle in the subject vehicle lane in which the different vehicle travels; and change content of the offset control according to the traveling position of the different vehicle in the subject vehicle lane.

In these examples, since a traveling position of another vehicle traveling in front of or behind the subject vehicle is taken into consideration, smooth offset control can be performed. Therefore, unnecessary movement in the lateral direction due to the offset control can be limited. As a result, the acceleration in the lateral direction that is likely to be troublesome for the driver is reduced, and thus the convenience of autonomous driving can be improved.

Further, according to another example, an automated driving control device is capable of performing automated driving without a periphery monitoring obligation of a driver, and the device includes: a traffic congestion recognition unit configured to recognize a traffic congestion in a periphery of a subject vehicle; and an offset control unit configured to execute an offset control that moves a traveling position of the subject vehicle in a left direction or a right direction with respect to a reference position when the subject vehicle travels by automated driving, and cancel the offset control when the traffic congestion recognition unit has recognized the traffic congestion in the periphery of the subject vehicle.

Further, according to another example, a non-transitory computer-readable storage medium stores an automated driving control program that is capable of performing automated driving without a periphery monitoring obligation of a driver and causes at least one processor to: execute an offset control that moves a traveling position of a subject vehicle in a left direction or a right direction with respect to a reference position, when the subject vehicle travels with automated driving; and cancel the offset control when having recognized the traffic congestion in a periphery of the subject vehicle.

In these examples, when traffic congestion in the periphery of the subject vehicle is recognized, the offset control is interrupted. Therefore, in a scene in which the subject vehicle travels in traffic congestion by autonomous driving, the occurrence frequency of acceleration in the lateral direction that is troublesome for the driver can be reduced. As a result, the driver feels comfortable in the autonomous driving period, and thus the convenience of autonomous driving can be improved.

Further, according to another example, a presentation control device is used for a subject vehicle having an automated driving function and controls presentation of information to a driver, and the device includes: an offset control recognition unit configured to recognize whether an offset control is executed, wherein the offset control moves a traveling position of the subject vehicle in a left direction or a right direction with respect to a reference position for causing the traveling position in a subject vehicle lane during a period in which the subject vehicle travels along a subject vehicle lane by an automated driving function; a monitoring obligation recognition unit configured to recognize whether a traveling control executed by the automated driving function requires a periphery monitoring obligation of the driver; and a notification control unit configured to execute notification related to the offset control by the automated driving function. The notification control unit cancels the notification related to the offset control executed when the periphery monitoring obligation of the driver is required.

Further, according to another example, a presentation control device is used for a subject vehicle having an automated driving function and controls presentation of information to a driver, and the device includes: an offset control recognition unit configured to recognize whether an offset control is executed, wherein the offset control moves a traveling position of the subject vehicle in a left direction or a right direction with respect to a reference position in a subject vehicle lane during a period in which the subject vehicle travels along a subject vehicle lane by an automated driving function; a monitoring obligation recognition unit configured to recognize whether a traveling control executed by the automated driving function requires a periphery monitoring obligation of the driver; and a notification control unit configured to execute notification related to the offset control by the automated driving function. The notification control unit weakens the notification related to the offset control executed when the periphery monitoring obligation of the driver is required as compared with the notification performed when the periphery monitoring obligation is not required.

Further, according to another example, a non-transitory computer-readable storage medium stores a presentation control program that is used for a subject vehicle having an automated driving function and controls presentation of information to a driver, and the program causes at least one processor to: recognize whether an offset control is executed, wherein the offset control moves a traveling position of the subject vehicle in a left direction or a right direction with respect to a reference position in a subject vehicle lane during a period in which the subject vehicle travels along a subject vehicle lane by an automated driving function; recognize whether a traveling control executed by the automated driving function requires a periphery monitoring obligation of the driver; cancel the notification related to the offset control executed when the periphery monitoring obligation of the driver is required.

Further, according to another example, a non-transitory computer-readable storage medium stores a presentation control program that is used for a subject vehicle having an automated driving function and controls presentation of information to a driver, and the program causes at least one processor to: recognize whether an offset control is executed, wherein the offset control moves a traveling position of the subject vehicle in a left direction or a right direction with respect to a reference position in a subject vehicle lane during a period in which the subject vehicle travels along a subject vehicle lane by an automated driving function; recognize whether a traveling control executed by the automated driving function requires a periphery monitoring obligation of the driver; and weaken the notification related to the offset control executed when the periphery monitoring obligation of the driver is required as compared with the notification performed when the periphery monitoring obligation is not required.

In these examples, in a case in which there is no periphery monitoring obligation by the driver, even when the driver does not see the periphery of the subject vehicle, the driver can recognize a reason for the occurrence of acceleration in the lateral direction due to the offset control through an offset notification related to the offset control. On the other hand, in a case in which there is a periphery monitoring obligation by the driver, since the driver is seeing the periphery of the subject vehicle, the driver can recognize the offset control and is less likely to feel uncomfortable about the acceleration in the lateral direction even when there is no offset notification or the offset notification is weakened. As a result, since the troublesomeness related to the offset notification can be reduced, the convenience of autonomous driving can be improved.

Hereinafter, multiple embodiments will be described with reference to the drawings. The same reference numerals are assigned to corresponding components in each embodiment, and thus, duplicate descriptions may be omitted. When only a portion of a configuration in each embodiment is described, with respect to other portions of the configuration, configurations of other embodiments described in advance can be applied. Further, not only combinations of the configurations explicitly shown in the description of the respective embodiments, but also the configurations of the multiple embodiments can be partially combined with each other even when the combinations are not explicitly shown if there is no problem in the combinations in particular.

### First Embodiment

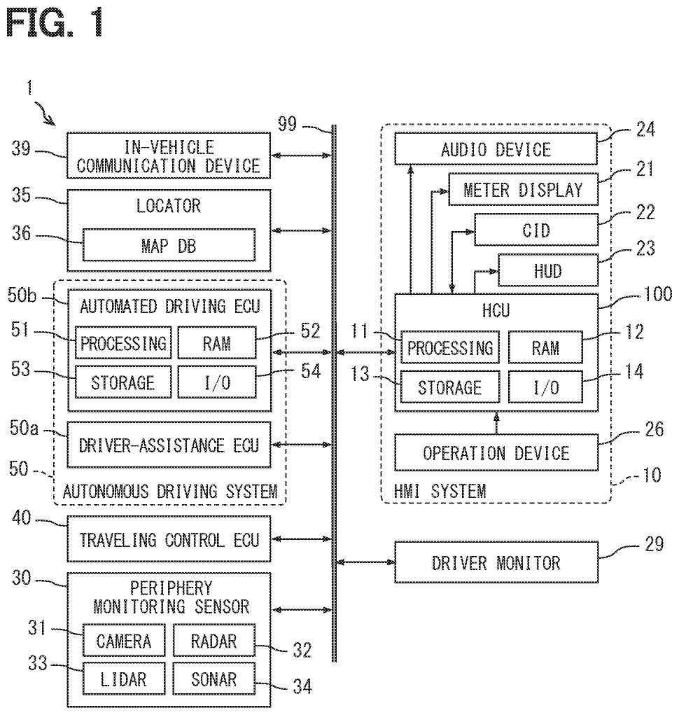

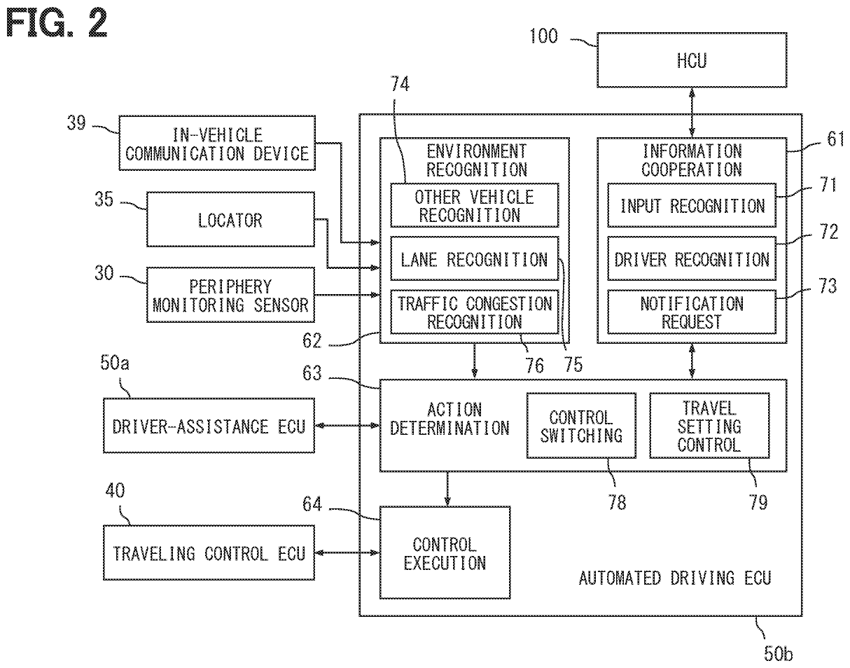

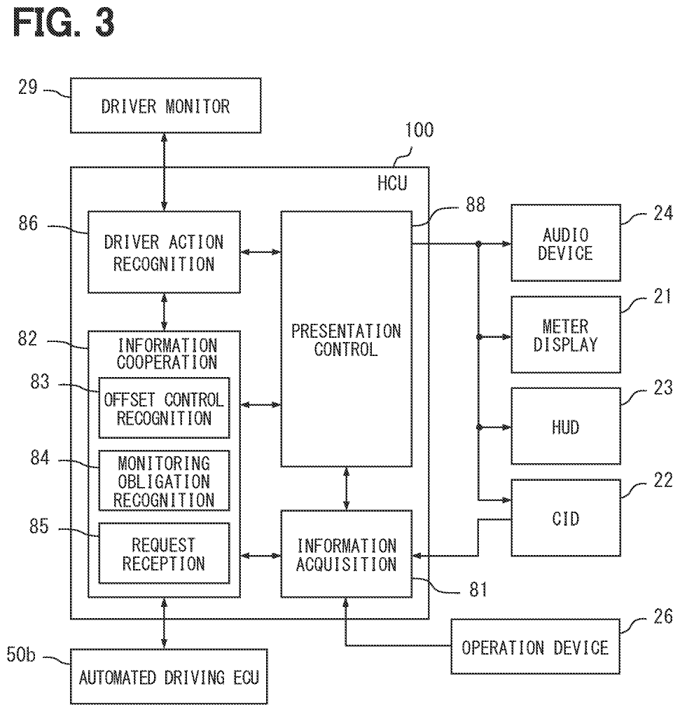

In a first embodiment of the present disclosure, an automated driving electronic control unit (ECU) 50b and a human machine interface control unit (HCU) 100 shown in FIG. 1 are provided in an in-vehicle network 1. The automated driving ECU 50b shown in FIGS. 1 and 2 implements a function of an automated driving control device. The HCU 100 shown in FIGS. 1 and 3 implements a function of a presentation control device.

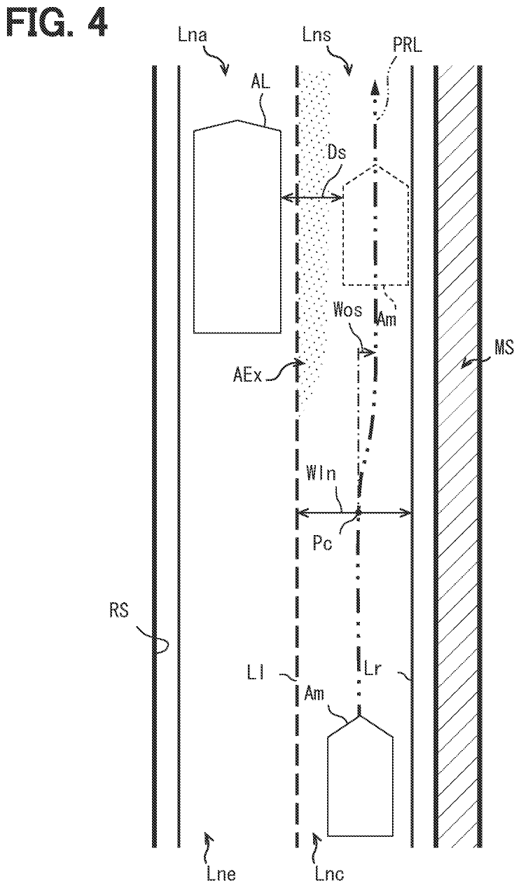

As shown in FIGS. 1 to 3, the automated driving ECU 50b and the HCU 100 are mounted on a vehicle (hereinafter, referred to as subject vehicle Am, see FIG. 4) together with a driving assistance ECU 50a. The automated driving ECU 50b constitutes an automated driving system 50 of the subject vehicle Am together with the driving assistance ECU 50a and the like. When the automated driving system 50 is mounted, the subject vehicle Am becomes an autonomous vehicle having an automated driving function.

The driving assistance ECU 50a is an in-vehicle ECU that implements a driving assistance function for assisting a driving operation of a driver in the automated driving system 50. The driving assistance ECU 50a enables partial autonomous driving control or advanced driving assistance of about Level 2 of an autonomous driving level defined by the Society of Automotive Engineers. Autonomous driving performed by the driving assistance ECU 50a is autonomous driving with a periphery monitoring obligation that requires monitoring of the periphery of the subject vehicle by visual observation of the driver.

The automated driving ECU 50b is an in-vehicle ECU that implements an autonomous traveling function capable of substituting a driving operation of the driver. The automated driving ECU 50b can perform autonomous traveling of Level 3 or higher in which the system is a control subject. The autonomous driving performed by the automated driving ECU 50b is autonomous driving that does not need to monitor the periphery of the subject vehicle, that is, eyes-off autonomous driving with no periphery monitoring obligation.

In an autonomous traveling period in which the subject vehicle Am autonomously travels by the autonomous driving function (autonomous traveling function) of Level 3 or higher according to the automated driving ECU 50b, a specific action (hereinafter, referred to as a second task) other than predetermined driving can be permitted by the driver. The second task is regularly permitted by the driver until a request for performing a driving operation by cooperation between the automated driving ECU 50b and the HCU 100, that is, a request for driving takeover occurs. For example, actions such as viewing of entertainment contents such as moving image contents, a device operation of a smartphone or the like, and meals are assumed as the second task.

The automated driving ECU 50b may perform autonomous driving control of Level 4 or higher. In the following description, autonomous driving control of Level 2 or lower by the driving assistance ECU 50a may be referred to as “driving assistance control”, autonomous driving control of Level 3 or higher by the automated driving ECU 50b may be referred to as “autonomous traveling control”.

The driving assistance ECU 50a, the automated driving ECU 50b, and the HCU 100 are communicably connected to a communication bus 99 of the in-vehicle network 1 mounted on the subject vehicle Am. A driver monitor 29, a periphery monitoring sensor 30, a locator 35, an in-vehicle communication device 39, a traveling control ECU 40, and the like are connected to the communication bus 99. These nodes connected to the communication bus 99 can communicate with each other. Specific nodes among the ECUs and the like may be directly electrically connected to each other and may communicate with each other without the communication bus 99.

The driver monitor 29 includes a near-infrared light source, a near-infrared camera, and a control unit that controls the near-infrared light source and the near-infrared camera. The driver monitor 29 is installed, for example, on an upper surface of a steering column portion or an upper surface of an instrument panel with the near-infrared camera facing a headrest portion of a driver's seat. The near-infrared camera may integrally include a meter display 21 or a center information display (hereinafter, referred to as CID) 22, which will be described later, and may be provided on any screen.

The driver monitor 29 uses the near-infrared camera to capture the driver's head radiated with near-infrared light by the near-infrared light source. The captured image by the near-infrared camera is subjected to image analysis by the control unit. The control unit extracts information such as a position of an eye point, a sight line direction, and an eye-opening degree of the driver from the captured image. The driver monitor 29 provides the information extracted by the control unit as driver status information to the HCU 100 and the automated driving ECU 50b.

The periphery monitoring sensor 30 is an autonomous sensor that monitors a surrounding environment of the subject vehicle Am. The periphery monitoring sensor 30 can detect a moving object and a stationary object from a detection range in the periphery of the subject vehicle. The periphery monitoring sensor 30 can detect a preceding vehicle, a following vehicle, a side vehicle, and the like traveling in the periphery of the subject vehicle Am as a moving object. In addition, the periphery monitoring sensor 30 can detect lane markings Lr and Ll (see FIG. 4) of a road on which the subject vehicle Am travels, as a stationary object. The periphery monitoring sensor 30 provides detection information of an object in the periphery of the subject vehicle to the driving assistance ECU 50a, the automated driving ECU 50b, and the like.

The periphery monitoring sensor 30 includes, for example, one or multiple camera units 31, millimeter wave radars 32, lidars 33, and sonars 34. The camera unit 31 may include a monocular camera, or may include a compound eye camera. The camera unit 31 is mounted on the subject vehicle Am so as to be able to capture a range in front of the subject vehicle Am. The camera unit 31 capable of capturing a side range and a rear range of the subject vehicle Am may be mounted on the subject vehicle Am. The camera unit 31 outputs, as detection information, at least one of imaging data obtained by capturing the periphery of the subject vehicle and an analysis result of the imaging data.

The millimeter wave radar 32 emits millimeter waves or quasi-millimeter waves toward the periphery of the subject vehicle. The millimeter wave radar 32 outputs detection information generated by a process for receiving reflected waves reflected by the moving object and the stationary object. The lidar 33 emits laser light toward the periphery of the subject vehicle. The lidar 33 outputs detection information generated by a process for receiving laser light reflected by a moving object and a stationary object present in an emitted range. The sonar 34 emits ultrasonic waves toward the periphery of the subject vehicle. The sonar 34 outputs detection information generated by a process for receiving ultrasonic waves reflected by a moving object, a stationary object, or the like present in the vicinity of the subject vehicle.

The locator 35 includes a global navigation satellite system (GNSS) receiver, an inertial sensor, and the like. The locator 35 sequentially measures a subject vehicle position and a traveling direction of the subject vehicle Am by combining a positioning signal received by the GNSS receiver, a measurement result of the inertial sensor, vehicle speed information output to the communication bus 99, and the like. The locator 35 sequentially outputs, as locator information, position information and direction information of the subject vehicle Am based on the positioning result to the communication bus 99.

The locator 35 further includes a map database (hereinafter, referred to as map DB) 36 that stores map data. The map DB 36 mainly includes a large capacity storage medium for storing a large number of three-dimensional map data and two-dimensional map data. The three-dimensional map data includes information necessary for advanced driving assistance and autonomous driving, such as three-dimensional shape information of a road and detailed information about each lane. The locator 35 reads map data about the periphery of a current position from the map DB 36, and provides the map data to the driving assistance ECU 50a, the automated driving ECU 50b, and the like together with the locator information.

The in-vehicle communication device 39 is an in-vehicle communication unit mounted on the subject vehicle Am and functions as a vehicle to everything (V2X) communication device. The in-vehicle communication device 39 transmits and receives information by wireless communication to and from a roadside device installed beside the road. As an example, the in-vehicle communication device 39 receives congestion information about the periphery of the current position and the traveling direction of the subject vehicle Am from the roadside device. The congestion information is, for example, VICS (registered trademark) information. The in-vehicle communication device 39 provides the received congestion information to the automated driving ECU 50b and the like.

The traveling control ECU 40 is an electronic control device mainly including a microcontroller. The traveling control ECU 40 has at least functions of a brake control ECU, a drive control ECU, and a steering control ECU. The traveling control ECU 40 continuously controls a braking force of each wheel, an output of an in-vehicle power source, and a steering angle based on any one of an operation command based on a driving operation of the driver, a control command of the driving assistance ECU 50a, and a control command of the automated driving ECU 50b. In addition, the traveling control ECU 40 generates vehicle speed information indicating a current traveling speed of the subject vehicle Am based on detection signals of wheel speed sensors provided in hub portions of wheels, and sequentially outputs the generated vehicle speed information to the communication bus 99.

Next, the HCU 100, the driving assistance ECU 50a, and the automated driving ECU 50b will be described in detail.

The HCU 100 constitutes a human machine interface (HMI) system 10 together with multiple display devices, an audio device 24, an operation device 26, and the like. The HMI system 10 has an input interface function for receiving operations performed by an occupant such as the driver of the subject vehicle Am, and an output interface function for presenting information to the driver.

Each display device presents information through a vision of the driver by image display or the like. The display device includes the meter display 21, the CID 22, and a head-up display (hereinafter, referred to as HUD) 23. The CID 22 has a function of a touch panel and detects a touch operation on a display screen by the driver or the like. The audio device 24 includes multiple speakers installed in a vehicle compartment in a manner of surrounding a driver's seat, and causes the speakers to reproduce a notification sound, a voice message, or the like in the vehicle compartment.

The operation device 26 is an input unit that receives a user operation performed by the driver or the like. For example, a user operation related to activation and stop of the autonomous driving function is input to the operation device 26. As an example, a driver input for instructing shift from the driving assistance control to the autonomous traveling control is input to the operation device 26. The operation device 26 includes a steering switch provided on a spoke portion of the steering wheel, an operation lever provided on a steering column portion, a voice input device for recognizing an utterance content of the driver, and the like.

The HCU 100 functions as the presentation control device, and integrally controls presentation to the driver such as information related to autonomous driving. The HCU 100 requests the driver to perform driving takeover based on the request for performing the driving operation by the automated driving ECU 50b. In addition, the HCU 100 can cooperate with the automated driving ECU 50b to allow execution of a second task by the driver, and reproduce moving image contents and the like related to the second task in a manner that does not interfere with a driving takeover request.

The HCU 100 mainly includes a control circuit including a processing unit 11, a RAM 12, a storage unit 13, an input and output interface 14, and a bus connecting the processing unit 11, the RAM 12, the storage unit 13, and the input and output interface 14. The processing unit 11 is hardware for a calculation process and is coupled to the RAM 12, and executes various processes for implementing a presentation control method according to the present disclosure by accessing the RAM 12. The processing unit 11 includes at least one processor core such as a central processing unit (CPU) and a graphics processing unit (GPU). The processing unit 11 may further include a field-programmable gate array (FPGA), a neural network processing unit (NPU), an IP core having another dedicated function, and the like. The RAM 12 may include a video RAM for generating image data. The processing unit 11 executes various processes for a presentation control process by accessing the RAM 12. The storage unit 13 includes a non-volatile storage medium. The storage unit 13 stores various programs (presentation control programs and the like) executed by the processing unit 11.

The HCU 100 includes multiple function units that integrally control information presentation to the driver by executing presentation control programs stored in the storage unit 13 by the processing unit 11. Specifically, the HCU 100 includes function units such as an information acquisition unit 81, an information cooperation unit 82, a driver action recognition unit 86, and a presentation control unit 88.

The information acquisition unit 81 acquires vehicle information indicating a state of the subject vehicle Am from the communication bus 99. The vehicle information includes, for example, vehicle speed information provided to the communication bus 99 by the traveling control ECU 40. In addition, the information acquisition unit 81 acquires operation information indicating the contents of the user operation from the CID 22, the operation device 26, and the like.

The information cooperation unit 82 cooperates with an information cooperation unit 61 (to be described later) of the automated driving ECU 50b, and recognizes an operation state of the autonomous driving function according to the automated driving system 50 by acquiring control status information indicating a state of the autonomous driving function. The information cooperation unit 82 provides, to the automated driving ECU 50b, the operation information recognized by the information acquisition unit 81, driver action information (to be described later) recognized by the driver action recognition unit 86, and the like. The information cooperation unit 82 includes an offset control recognition unit 83, a monitoring obligation recognition unit 84, and a request reception unit 85 as sub-function units for information cooperation.

The offset control recognition unit 83 recognizes information related to offset control (see FIG. 4) to be described later in a period in which the subject vehicle Am travels under the driving assistance control and the autonomous traveling control. Specifically, the offset control recognition unit 83 recognizes whether the offset control is performed by the automated driving system 50, whether the execution of the offset control is scheduled, and whether the offset control being performed is to be terminated.

When the autonomous driving function according to the automated driving system 50 is in an operation state, the monitoring obligation recognition unit 84 recognizes whether there is a periphery monitoring obligation by the driver in the traveling control performed by the autonomous driving function. That is, based on the control status information acquired from the automated driving ECU 50b, the monitoring obligation recognition unit 84 determines which of the driving assistance control and the autonomous traveling control is traveling control being performed. Specifically, the monitoring obligation recognition unit 84 recognizes information such as whether a steering operation by the driver is necessary, whether the periphery monitoring by the driver is necessary, and whether an unnecessary state of the periphery monitoring is to be terminated.

The request reception unit 85 acquires an issuing request of a notification output by the automated driving ECU 50b. The request reception unit 85 acquires, from the automated driving ECU 50b, an issuing request of a driving takeover request to the driver, an issuing request of a control shift notification related to the shift from the driving assistance control to the autonomous traveling control, an issuing request of an offset notification related to the offset control (to be described later), and the like. The request reception unit 85 cooperates with the presentation control unit 88 and controls contents and execution timings of notifications based on the issuing requests of the notifications.

The driver action recognition unit 86 recognizes a status of the driver based on the driver status information acquired from the driver monitor 29. As an example, the driver action recognition unit 86 recognizes the monitoring information indicating whether the driver is monitoring the periphery of the subject vehicle Am, task information indicating contents of the second task being performed by the driver, and posture information indicating the suitability of a driving posture of the driver. For example, the task information is information such as operating a smartphone, watching a screen of the CID 22, and operating a touch panel of the CID 22. The driver action recognition unit 86 provides the monitoring information, the task information, the posture information, and the like as driver action information to the information cooperation unit 82 and the presentation control unit 88.

The presentation control unit 88 integrally controls provision of information to the driver using each display device and the audio device 24. The presentation control unit 88 performs content provision and information presentation in accordance with an operation state of the autonomous driving. When the execution of the autonomous traveling control in an eyes-off state with no periphery monitoring obligation is recognized by the monitoring obligation recognition unit 84, the presentation control unit 88 enables reproduction of the moving image contents and the like. In addition, the presentation control unit 88 issues the driving takeover request, the control shift notification, the offset notification, and the like based on the issuing requests acquired by the request reception unit 85.

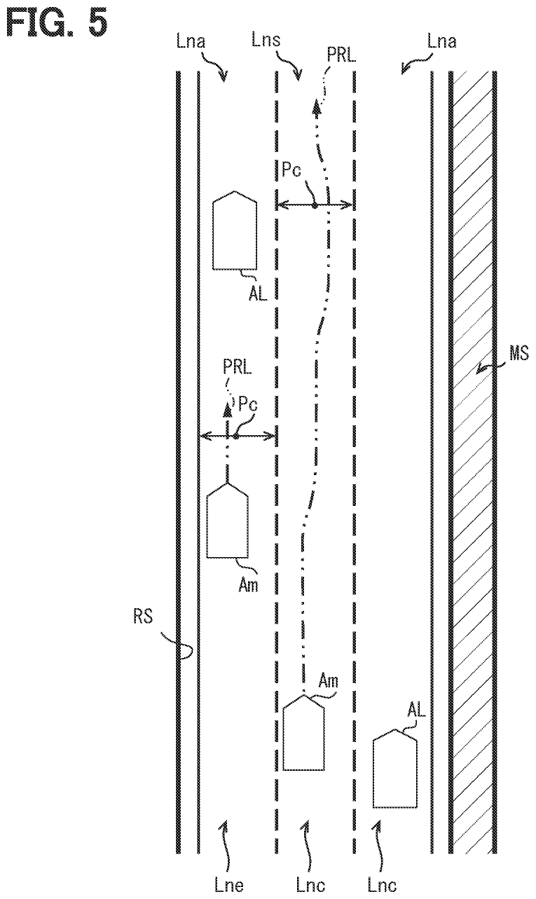

The driving assistance ECU 50a is a computer mainly including a control circuit including a processing unit, a RAM, a storage unit, an input and output interface, a bus connecting the processing unit, the RAM, the storage unit, and the input and output interface, and the like. The driving assistance ECU 50a implements driving assistance functions of adaptive cruise control (ACC), lane trace control (LTC), and the like by executing programs by the processing unit. The driving assistance ECU 50a performs driving assistance control for causing the subject vehicle Am to travel along a traveling subject vehicle lane Lns by cooperation with the functions of the ACC and the LTC. In addition, the driving assistance ECU 50a performs offset control (see FIGS. 4 and 5) as one of the functions of the LTC.

### <Details of Offset Control>

A function of the offset control is implemented not only in the driving assistance ECU 50a but also in an action determination unit 63 (to be described later) of the automated driving ECU 50b. The driving assistance ECU 50a and the automated driving ECU 50b normally control, to substantially a central portion of the subject vehicle lane Lns, a traveling position of the subject vehicle Am on the subject vehicle lane Lns in a driving assistance period or an autonomous traveling period in which the subject vehicle Am autonomously travels along the subject vehicle lane Lns.

The central portion is a position separated by a distance of half a lane width Win of the subject vehicle lane Lns from either a left or right lane marking Lr or Ll partitioning the subject vehicle lane Lns. The central portion serves as a reference position Pc when the offset control is performed. The reference position Pc may be adjustable from the central portion to the left and right based on a steering operation of the driver during the autonomous traveling and a user operation for changing the setting.

The offset control is performed in a scene in which the subject vehicle Am passes a parallel traveling vehicle AL traveling on an adjacent lane Lna, or in a scene in which the subject vehicle Am gets passed by the parallel traveling vehicle AL traveling on the adjacent lane Lna. In the offset control, the traveling position of the subject vehicle Am in the subject vehicle lane Lns is moved from the reference position Pc in either a leftward or rightward direction so as to be separated from the parallel traveling vehicle AL. When the adjacent lanes Lna are present on both left and right sides of the subject vehicle lane Lns (see FIG. 5), offset control from the reference position Pc to the left and right is performed according to the presence of the parallel traveling vehicle AL traveling on each adjacent lane Lna. On the other hand, when the parallel traveling vehicle AL is not present on the adjacent lanes Lna, the subject vehicle Am continues to travel through the reference position Pc which is the center of the subject vehicle lane Lns. In addition, when the parallel traveling vehicles AL are present on both the left and right sides, control is performed such that the subject vehicle Am is slightly offset in a direction away from the parallel traveling vehicle AL on the right side (a median strip MS side) that is estimated to travel at a higher speed than the subject vehicle Am. A movement amount (hereinafter, an offset control amount Wos) of the subject vehicle Am in the lateral direction by the offset control is adjusted within a range in which the subject vehicle Am does not come into contact with the left and right lane markings Lr and Ll.

In the offset control, a scheduled traveling line PRL that defines the traveling position of the subject vehicle Am in the subject vehicle lane Lns is generated in a shape shifted in a direction away from the parallel traveling vehicle AL. Offset of the traveling position of the subject vehicle Am described above is implemented by the traveling control according to the scheduled traveling line PRL. The offset control may be implemented by a control logic that sets at least a traveling prohibition area AEx (see a dot range in FIG. 4) on a road surface of the subject vehicle lane Lns according to a position of the parallel traveling vehicle AL and adjusts the traveling position of the subject vehicle Am so as not to pass through the traveling prohibition area AEx. According to the execution of the offset control described above, since a distance Ds in the lateral direction between the parallel traveling vehicle AL and the subject vehicle Am can be ensured, it is possible to reduce the uneasiness of the driver.

The automated driving ECU 50b has a higher calculation capability than the driving assistance ECU 50a, and can perform at least traveling control corresponding to the ACC and the LTC. In a scene in which the autonomous traveling control is temporarily interrupted, the automated driving ECU 50b may perform the driving assistance control with a periphery monitoring obligation by the driver, instead of the driving assistance ECU 50a. Similar to the HCU 100, the automated driving ECU 50b is a computer mainly including a control circuit including a processing unit 51, a RAM 52, a storage unit 53, an input and output interface 54, a bus connecting the processing unit 51, the RAM 52, the storage unit 53, and the input and output interface 54, and the like. The processing unit 51 executes various processes for implementing an autonomous driving control method according to the present disclosure by accessing the RAM 52. The storage unit 53 stores various programs (such as an autonomous driving control program) executed by the processing unit 51. According to the execution of the programs by the processing unit 51, in the automated driving ECU 50b, the information cooperation unit 61, an environment recognition unit 62, an action determination unit 63, a control execution unit 64, and the like are constructed as multiple function units for implementing the autonomous driving function.

The information cooperation unit 61 provides information to the information cooperation unit 82 of the HCU 100 and acquires information from the information cooperation unit 82. The cooperation of the information cooperation units 61 and 82 allows the automated driving ECU 50b and the HCU 100 to share the acquired information. The information cooperation unit 61 generates control status information indicating the state of the autonomous driving function and provides the generated control status information to the information cooperation unit 82. The information cooperation unit 61 includes an input recognition unit 71, a driver recognition unit 72, and a notification request unit 73 as sub-function units for information cooperation.

The input recognition unit 71 acquires the operation information of the driver from the information cooperation unit 82. The input recognition unit 71 recognizes the user operation input to the CID 22, the operation device 26, and the like based on the operation information. As an example, the input recognition unit 71 recognizes a driver input that instructs the shift from the driving assistance control to the autonomous traveling control.

The driver recognition unit 72 acquires the driver action information from the information cooperation unit 82. Based on the driver action information, the driver recognition unit 72 recognizes the state of the driver in at least the autonomous traveling period. Specifically, the driver recognition unit 72 recognizes the presence or absence of execution of the periphery monitoring by the driver and the contents of the second task to be performed by the driver. The driver recognition unit 72 may acquire driver status information provided by the driver monitor 29 as information for recognizing the status of the driver instead of the driver action information or together with the driver action information.

The driver recognition unit 72 further recognizes poor physical condition of an occupant of the subject vehicle Am including the driver. The poor physical condition is, for example, a carsick of the occupant. A fever, headache, and the like of the occupant may be further recognized as the poor physical condition. The driver recognition unit 72 may be able to recognize the poor physical condition of the occupant using a driver input that reports the poor physical condition of the occupant, physical condition information received from a wearable terminal worn by the occupant, measurement information from a biosensor installed on a seat or the like, and the like.

The notification request unit 73 outputs an issuing request for a notification to the request reception unit 85 to enable the HCU 100 to issue a notification in synchronization with the operation state of the autonomous driving function. As described above, the notification request unit 73 transmits, to the request reception unit 85, an issuing request for the driving takeover request, an issuing request for a shift notification, an issuing request for the offset notification, and the like as the issuing request for the notification related to the autonomous driving.

The environment recognition unit 62 combines the locator information and the map data acquired from the locator 35 with the detection information acquired from the periphery monitoring sensor 30, and recognizes a traveling environment in the periphery of the subject vehicle Am. The environment recognition unit 62 includes an other vehicle recognition unit 74, a lane recognition unit 75, and a traffic congestion recognition unit 76 as sub-function units for traveling environment recognition.

The other vehicle recognition unit 74 recognizes a relative position, a relative speed, and the like of a dynamic target in the periphery of the subject vehicle, such as another vehicle. The other vehicle recognition unit 74 recognizes at least a preceding vehicle traveling in front of the subject vehicle Am on the subject vehicle lane Lns and a parallel traveling vehicle AL traveling on an adjacent lane Lna of the subject vehicle lane Lns. The other vehicle recognition unit 74 may be also referred to as a different vehicle recognition unit 74.

The other vehicle recognition unit 74 recognizes a positional relationship between each of the lane markings Lr and Ll and each of other vehicles (different vehicles) based on detection information on the lane markings Lr and Ll of a road on which the subject vehicle Am travels. The other vehicle recognition unit 74 specifies relative positions of a pair of left and right lane markings Lr and Ll that define the subject vehicle lane Lns, and recognizes a traveling position in the lateral direction within the subject vehicle lane Lns at least for a preceding vehicle traveling on the subject vehicle lane Lns. The other vehicle recognition unit 74 may recognize a traveling position in the lateral direction within the subject vehicle lane Lns even for a following vehicle traveling on the subject vehicle lane Lns.

The other vehicle recognition unit 74 determines whether a preceding vehicle or the like traveling on the same subject vehicle lane Lns as the subject vehicle Am is traveling deviated from the center of the subject vehicle lane Lns. Specifically, when a traveling position of the preceding vehicle or the like deviates from the reference position Pc in either a left or right direction beyond a predetermined threshold, the other vehicle recognition unit 74 determines that the preceding vehicle or the like is traveling deviated from the center. The threshold for determining the deviation of the preceding vehicle or the like in the lateral direction is set to be, for example, a value approximately equal to the offset control amount Wos or a value slightly smaller than the offset control amount Wos.

The lane recognition unit 75 recognizes information related to the road on which the subject vehicle Am travels. Specifically, the lane recognition unit 75 recognizes whether the road on which the subject vehicle Am travels or a road to be traveling is within a preset permitted area or a restricted permitted area. The information indicating whether the area is the permitted area or the restricted permitted area may be recorded in the map data stored in the map DB 36 or may be included in reception information received by the in-vehicle communication device 39.

Here, the permitted area and the restricted permitted area can correspond to an operational design domain in which autonomous driving with no periphery monitoring obligation by the driver is permitted under regulation. More specifically, the autonomous driving with no periphery monitoring obligation includes, as multiple execution modes, traffic congestion limit control (hereinafter, referred to as congested time Level 3) performed only for traveling during traffic congestion and area limit control (hereinafter, referred to as area Level 3) performed only for traveling in a specific area. On a road in the permitted area, execution of both congested time Level 3 and area Level 3 are permitted, and execution of only congested time Level 3 is permitted on a road in the restricted permitted area. On a road that is not included in either the permitted area or the restricted permitted area, traveling in the autonomous driving with no periphery monitoring obligation is prohibited.

In addition, the lane recognition unit 75 recognizes the number of lanes of the road on which the vehicle travels, based on the map data and the like. When the subject vehicle Am travels on a road including multiple lanes by autonomous driving, the lane recognition unit 75 specifies the subject vehicle lane Lns on which the subject vehicle Am travels among the multiple lanes based on the locator information, the detection information, and the like. The lane recognition unit 75 determines whether the subject vehicle lane Lns is an edge lane Lne or a central lane Lnc. The edge lane Lne is one lane that is located on an outermost side of the road and faces a road edge RS. The central lane Lnc is one or multiple lanes excluding the edge lane Lne among the multiple lanes.

As a specific example, when the subject vehicle Am is traveling on a left-hand traffic road (see FIG. 4) including two lanes per direction, a traveling lane located on a left side of the two lanes is the edge lane Lne. On the other hand, a passing lane that is located on a right side and faces the median strip MS of the two lanes is the central lane Lnc.

As another specific example, when the subject vehicle Am is traveling on a left-hand traffic road (see FIG. 5) including three lanes per direction, a traveling lane located on a leftmost side among the three lanes is the edge lane Lne. On the other hand, a passing lane that is located on a rightmost side and faces the median strip MS among the three lanes and a traveling lane that is located at the center of the three lanes are both the central lanes Lnc. The edge lane Lne is not limited to a traveling lane and may be an uphill lane, a branched lane, a merging lane, or the like.

The traffic congestion recognition unit 76 recognizes traffic congestion in the periphery of the subject vehicle Am by combining the detection information from the periphery monitoring sensor 30 and the vehicle speed information from the traveling control ECU 40 and the like. The traffic congestion recognition unit 76 determines whether the periphery is in a traffic congestion state, predicts that the traffic congestion is to be resolved, and determines whether the traffic congestion is resolved. The traffic congestion recognition unit 76 may use traffic congestion information received by the in-vehicle communication device 39 to perform a determination related to traffic congestion.

When a current vehicle speed of the subject vehicle Am is equal to or lower than a traffic congestion speed (for example, about 10 km/h) and there is a preceding vehicle traveling on the subject vehicle lane Lns, the traffic congestion recognition unit 76 determines that the periphery of the subject vehicle Am are in a traffic congestion state. After determining that the periphery of the subject vehicle is in a traffic congestion state, when the vehicle speed of the subject vehicle Am exceeds the traffic congestion speed, the traffic congestion recognition unit 76 predicts that the traffic congestion in the periphery of the subject vehicle is to be resolved. After predicting that the traffic congestion is to be resolved, when the vehicle speed of the subject vehicle Am is equal to or lower than the traffic congestion speed again, the traffic congestion recognition unit 76 cancels the prediction that the traffic congestion is to be resolved. Furthermore, after predicting that the traffic congestion in the periphery of the subject vehicle is to be resolved, when the vehicle speed of the subject vehicle Am or a vehicle speed of the preceding vehicle exceeds a traffic congestion resolution speed (for example, about 60 km/h), the traffic congestion recognition unit 76 determines that the traffic congestion is resolved.

The action determination unit 63 cooperates with the HCU 100 and controls driving takeover between the automated driving system 50 and the driver. When the automated driving system 50 has a control right of the driving operation, the action determination unit 63 generates a scheduled traveling line PRL (see FIG. 4) on which the subject vehicle Am travels based on a recognition result of the traveling environment generated by the environment recognition unit 62. The action determination unit 63 includes a control switching unit 78 and a travel setting control unit 79 as sub-function units that control an operation state of the autonomous driving function.

The control switching unit 78 cooperates with the driving assistance ECU 50a and switches between the driving assistance control with a periphery monitoring obligation by the driver and the autonomous traveling control with no periphery monitoring obligation by the driver. As an example, the control switching unit 78 switches a control state from the driving assistance control to the autonomous traveling control when the traffic congestion recognition unit 76 recognizes an entry of the subject vehicle Am into the traffic congestion in the permitted area or the restricted permitted area. In another example, the control switching unit 78 shifts from the driving assistance control to the autonomous traveling control based on the driver input recognized by the input recognition unit 71.

In addition, the control switching unit 78 switches an execution mode of the autonomous traveling control with no periphery monitoring obligation among the multiple execution modes including congested time Level 3 and area Level 3 described above. As an example, the control switching unit 78 shifts from area Level 3 to congested time Level 3 when the traffic congestion recognition unit 76 recognizes the entry of the subject vehicle Am into the traffic congestion in the permitted area. Further, when the traffic congestion recognition unit 76 recognizes that the traffic congestion is resolved, the control switching unit 78 shifts from congested time Level 3 to area Level 3.

The travel setting control unit 79 changes setting of a parameter related to the autonomous traveling control based on the information recognized by the information cooperation unit 61 and the environment recognition unit 62. The travel setting control unit 79 performs the offset control (see FIGS. 4 and 5), which is performed in the driving assistance period in which the subject vehicle Am travels under the driving assistance control, also in the autonomous driving period in which the subject vehicle Am travels under the autonomous traveling control. According to the execution of the offset control by the travel setting control unit 79, the offset control amount Wos (see FIG. 4) is set in the scheduled traveling line PRL generated by the action determination unit 63.

When the automated driving ECU 50b has the control right of the driving operation, the control execution unit 64 performs acceleration and deceleration control, steering control, and the like of the subject vehicle Am in accordance with the scheduled traveling line PRL generated by the action determination unit 63 in cooperation with the traveling control ECU 40. Specifically, the control execution unit 64 generates control commands based on the scheduled traveling line PRL, and sequentially outputs the generated control commands to the traveling control ECU 40.

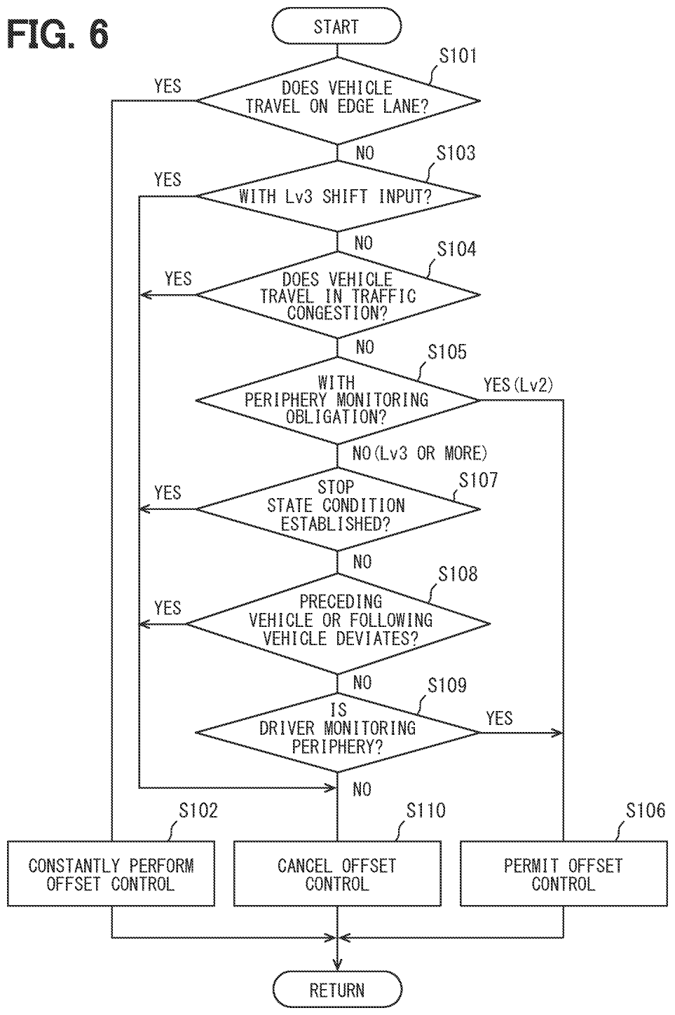

Next, details of the offset control performed by the automated driving ECU 50b will be further described. The travel setting control unit 79 changes and invalidates contents of the offset control in accordance with conditions such as a position of the subject vehicle lane Lns, an operation by the driver, traveling positions of the preceding and following vehicles, the status of the driver, and whether the vehicle is congested, by performing a control setting process (see FIG. 6). Hereinafter, multiple scenes in which the contents of the offset control are changed or invalidated based on the control setting process will be described in order. The control setting process is started, for example, based on the activation of the autonomous driving function after a power supply of the automated driving ECU 50b is in an on-state, and is repeatedly started until the power supply of the automated driving ECU 50b is in an off-state.

### <Change in Contents of Offset Control According to Position of Subject Vehicle Lane Lns>

When the vehicle travels on a road including multiple lanes, the travel setting control unit 79 changes the contents of the offset control according to the position of the subject vehicle lane Lns recognized by the lane recognition unit 75. When the central lane Lnc (see FIG. 5 and the like) among the multiple lanes is the subject vehicle lane Lns (S101: NO) and a predetermined condition is satisfied, the travel setting control unit 79 permits the execution of the offset control in a direction away from the parallel traveling vehicle AL on the adjacent lane Lna (S106).

On the other hand, when the edge lane Lne (see FIG. 5) is the subject vehicle lane Lns (S101: YES), the travel setting control unit 79 changes the setting to constantly perform the offset control (S102). As described above, the travel setting control unit 79 performs the offset control in a direction approaching the road edge RS even if the parallel traveling vehicle AL is not present. As a result, in an autonomous traveling period with no periphery monitoring obligation in which a low-speed limit (for example, about 60 km/h) is set, the subject vehicle Am autonomously travels along a scheduled traveling line PRL defined outside (left side) the reference position Pc. As described above, according to the continuous offset toward the road edge RS, even if the vehicle is traveling on the edge lane Lne having a low cruising speed, the driver is less likely to feel uneasy about the parallel traveling vehicle AL on the adjacent lane Lna that passes the subject vehicle Am.

Even in the offset control performed by the driving assistance ECU 50a, when the subject vehicle lane Lns is the edge lane Lne, a continuous shift of the reference position Pc in a direction approaching the road edge RS may also be performed.

### <Cancel of Offset Control by Driver Input>

When the driver input that instructs the shift from the driving assistance control to the autonomous traveling control is recognized by the input recognition unit 71 (S103: YES), the travel setting control unit 79 cancels the offset control (S110). When the driver input is recognized in the driving assistance period with the offset control, the travel setting control unit 79 instructs the driving assistance ECU 50a to cancel the offset control being performed. The offset control is terminated before the shift from the driving assistance control to the autonomous traveling control is performed, by cooperation between the travel setting control unit 79 and the driving assistance ECU 50a. As a result, the automated driving ECU 50b moves the traveling position of the subject vehicle Am to the reference position Pc (a center of the lane), and then starts the autonomous traveling control with no periphery monitoring obligation.

As described above, in the above-described scene in which the cancellation of the offset control and the shift to the autonomous traveling control are consecutively performed, a termination notification of the offset control (hereinafter, referred to as an offset termination notification) and a shift notification to the autonomous traveling control (hereinafter, referred to as a control shift notification) are issued by the HMI system 10. In the HMI system 10, a virtual image display by a HUD 23 and a screen display or the like by the meter display 21 and the CID 22 are combined to issue the offset termination notification and the control shift notification.

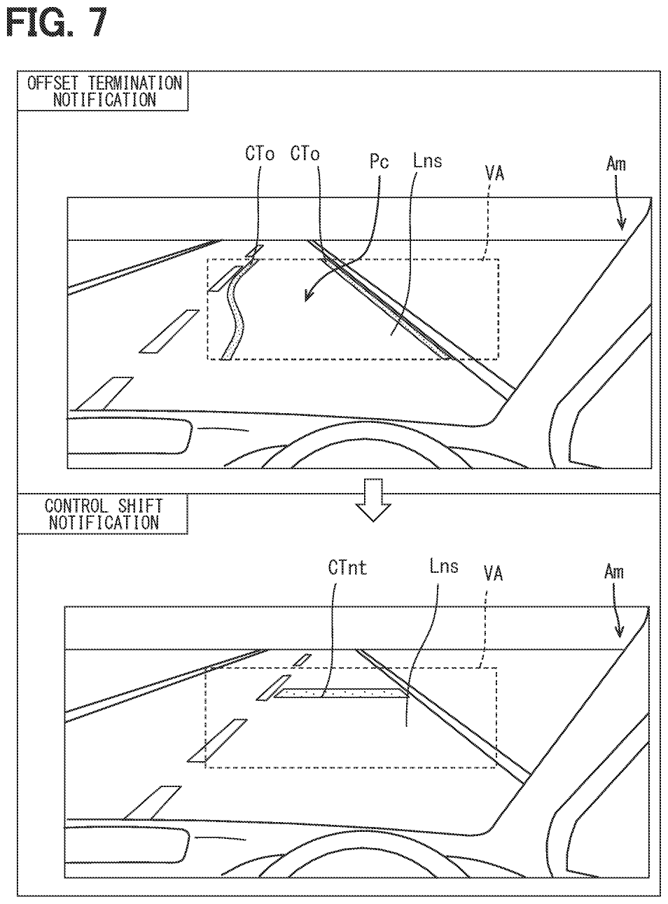

The HCU 100 sequentially issues the offset termination notification and the control shift notification using one information presentation pattern in the scene (see FIG. 7). In the information presentation pattern, the notification request unit 73 requests the HCU 100 to issue the offset termination notification in a period in which the driving assistance control is continued, based on the recognition of the driver input by the input recognition unit 71. The HCU 100 starts the offset termination notification (see an upper part of FIG. 7) based on the reception of the issuing request by the request reception unit 85. In the offset termination notification, an offset content CTo is displayed as a virtual image in an angle of view VA of the HUD 23. The offset content CTo is a superimposed content that extends in a band shape on a road surface in front of the subject vehicle lane Lns and visualizes the scheduled traveling line PRL of the subject vehicle Am in a foreground. The offset content CTo notices in advance movement in a lateral direction of returning to the center of the subject vehicle lane Lns.

The notification request unit 73 requests the HCU 100 to issue the shift notification to the autonomous traveling control based on the termination of the offset control. The HCU 100 terminates the offset termination notification based on the reception of the issuing request by the request reception unit 85, and then starts the control shift notification (see a lower part of FIG. 7). In the control shift notification, a shift notification content CTnt is displayed as a virtual image in the angle of view VA. The shift notification content CTnt is a superimposed content superimposed on a road surface in front of the subject vehicle lane Lns, and visualizes a control shift point in the foreground.

In addition, the HCU 100 issues the offset termination notification and the control shift notification in parallel as another information presentation pattern in the scene described above. In the information presentation pattern, the notification request unit 73 requests the HCU 100 to issue the offset termination notification and the control shift notification in parallel based on the recognition of the driver input by the input recognition unit 71. Based on the reception of the issuing request by the request reception unit 85, the HCU 100 starts both the offset termination notification and the control shift notification. In this case, both the offset content CTo and the shift notification content CTnt are displayed as virtual images in the angle of view VA. The HCU 100 may change the information presentation pattern based on the setting by the user, or may change the information presentation pattern according to the traveling environment recognized by the environment recognition unit 62.

### <Cancel of Offset Control According to Traveling Positions of Preceding and Following Vehicles>

When the preceding vehicle or the following vehicle traveling on the same subject vehicle lane Lns as the subject vehicle Am is recognized by the other vehicle recognition unit 74, the travel setting control unit 79 changes the contents of the offset control according to the traveling positions of the preceding vehicle and the following vehicle in the subject vehicle lane Lns. Specifically, in a scene in which both the preceding vehicle and the following vehicle are present, when both the preceding vehicle and the following vehicle are traveling substantially at the center of the subject vehicle lane Lns (S108: NO), the travel setting control unit 79 permits the execution of the offset control (S106). On the other hand, when one of the preceding vehicle and the following vehicle is traveling deviated from the reference position Pc which is the center of the subject vehicle lane Lns (S108: YES), the travel setting control unit 79 cancels the offset control (S110).

When the preceding vehicle is present and the following vehicle is not present, the travel setting control unit 79 cancels the offset control when the traveling position of the preceding vehicle is shifted from the center. When the preceding vehicle is not present and the following vehicle is present, the travel setting control unit 79 cancels the offset control when the traveling position of the following vehicle is shifted from the center. The travel setting control unit 79 may not perform a process for determining whether the offset control is possible based on the traveling position of the following vehicle.

### <Cancel of Offset Control in Traffic Congestion>

When the traffic congestion recognition unit 76 recognizes the traffic congestion in the periphery of the subject vehicle Am (S104: YES), the travel setting control unit 79 cancels the offset control (S110). By canceling the offset control, movement in a left-right direction is prevented in a period in which the vehicle travels in traffic congestion, so that the driver is less likely to be swung to the left or right.

As an example, when the entry into the traffic congestion is recognized in the driving assistance period with the offset control while the vehicle travels in the restricted permitted area, the travel setting control unit 79 terminates the offset control before the control switching unit 78 switches from the driving assistance control to the autonomous traveling control (congested time Level 3). As a result, the automated driving ECU 50b returns the traveling position of the subject vehicle Am to the reference position Pc after the periphery of the subject vehicle become congested. The automated driving ECU 50b shifts to the autonomous traveling control with no periphery monitoring obligation in a state in which the vehicle travels at the center of the subject vehicle lane Lns.

Here, the travel setting control unit 79 can change an execution order of a termination process of the above-described offset control and a shift process to the autonomous traveling control. Specifically, the travel setting control unit 79 continues the offset control until the switching from the driving assistance control to the autonomous traveling control by the control switching unit 78 is completed. As a result, the automated driving ECU 50b completes the shift of the control state in a state in which the offset control is continued, and returns the traveling position of the subject vehicle Am to the reference position Pc after the autonomous traveling control of congested time Level 3 is started.

The switching of the processing order as described above may be performed by changing settings by the user, or may be performed according to the traveling environment recognized by the environment recognition unit 62. Further, in the offset control performed by the driving assistance ECU 50a, the offset control may be canceled when the vehicle travels in the traffic congestion.

### <Cancel of Offset Control According to Status of Driver>

When the subject vehicle Am autonomously travels under the autonomous traveling control (S105: NO), since acceleration in a lateral direction due to the offset control is likely to be troublesome for the driver, the travel setting control unit 79 can limit (cancel) the execution of the offset control. In the autonomous traveling period, the travel setting control unit 79 determines whether to perform the offset control according to the status of the driver recognized by the driver recognition unit 72.

Specifically, when the status of the driver matches preset stop state conditions (S107: YES), the travel setting control unit 79 cancels the offset control (S110). In the travel setting control unit 79, a poor physical condition of the occupant including the driver is set as one of the stop state conditions. When the poor physical condition of the occupant, specifically, a carsick of the driver or the like is recognized by the driver recognition unit 72, the travel setting control unit 79 establishes a stop state condition and does not perform the offset control. The travel setting control unit 79 is set to perform a specific second task as another one of the stop state conditions. When the driver is performing the second task of reading character information, the travel setting control unit 79 establishes a stop state condition so that the offset control is not performed.

The travel setting control unit 79 determines whether to perform offset control based on whether the driver is monitoring the periphery, as another status of the driver recognized by the driver recognition unit 72. When the driver is monitoring the periphery (S109: YES), the travel setting control unit 79 permits the execution of the offset control in the same manner as in the driving assistance period in which the vehicle travels under the driving assistance control (S106). On the other hand, when the driver is not monitoring the periphery (S109: NO), the travel setting control unit 79 cancels the offset control (S110).

In the first embodiment described above, the troublesomeness related to the offset control can be reduced. More specifically, in the first embodiment, the execution of the offset control is limited when a predetermined condition is satisfied in the autonomous driving period in which the subject vehicle Am travels under the autonomous traveling control with no periphery monitoring obligation. Therefore, in a scene in which the driver does not see the periphery of the subject vehicle Am, an occurrence frequency of acceleration in the lateral direction that is troublesome for the driver can be reduced. As a result, the driver feels comfortable in the autonomous driving period, and thus the convenience of autonomous driving can be improved.

In the first embodiment, the status of the driver is recognized, and the travel setting control unit 79 determines whether to cancel the offset control in the autonomous driving period according to the status of the driver. As a result, the offset control at the timing that is likely to be troublesome for the driver can be appropriately canceled, and thus the comfort in the autonomous driving period increases.

In addition, in the first embodiment, whether the driver is monitoring the periphery in the autonomous driving period with no periphery monitoring obligation is recognized as the status of the driver. When the driver is not monitoring the periphery, the travel setting control unit 79 cancels the offset control. Therefore, a scene in which the driver, who does not see the periphery of the subject vehicle Am, feels uneasy about the acceleration due to the offset control is less likely to occur. On the other hand, when the driver is monitoring the periphery, the execution of the offset control is permitted. As a result, since the distance Ds between the parallel traveling vehicle AL and the subject vehicle Am is ensured, the uneasiness of the driver in the autonomous driving period can be reduced.

Further, in the first embodiment, in the autonomous driving period, for example, a poor physical condition of the driver such as a carsick is recognized as the status of the driver. When the poor physical condition of the driver is recognized, the travel setting control unit 79 cancels the offset control. Therefore, a situation in which the poor physical condition of the driver further deteriorates by the acceleration in the lateral direction due to the offset control is less likely to occur.

In the first embodiment, in the autonomous driving period, the contents of the second task performed by the driver are recognized as the status of the driver. The travel setting control unit 79 determines whether to cancel the offset control according to the contents of the second task to be performed by the driver. According to the above description, the offset control that hinders the second task can be appropriately prevented, and thus the convenience of autonomous driving can be improved.

In the first embodiment, when the driver is reading characters as the second task, the travel setting control unit 79 cancels the offset control. Therefore, a situation in which the acceleration in the lateral direction due to the offset control induces the carsick of the driver is even less likely to occur.

In the first embodiment, the contents of the offset control are changed according to the position of the subject vehicle lane Lns on which the subject vehicle Am travels. Therefore, in a period in which the vehicle travels on a road including multiple lanes by autonomous driving, unnecessary movement in the lateral direction due to the offset control can be limited. As a result, the driver can comfortably spend the autonomous driving period.

In the first embodiment, when the subject vehicle Am travels on a road including multiple lanes, the position of the subject vehicle lane Lns is recognized. When the central lane Lnc is the subject vehicle lane Lns, the travel setting control unit 79 normally performs the offset control in a direction away from the parallel traveling vehicle AL on the adjacent lane Lna. On the other hand, when the edge lane Lne is the subject vehicle lane Lns, the travel setting control unit 79 performs the offset control in a direction approaching the road edge RS even if the parallel traveling vehicle AL is not present.

When the subject vehicle Am travels on the edge lane Lne, a difference in speed between the subject vehicle Am and the parallel traveling vehicle AL traveling on the adjacent lane Lna increases, and thus multiple parallel traveling vehicles AL pass the subject vehicle Am. As a result, when the offset control is normally performed, the movement in the lateral direction may be repeated. However, if the offset control toward the road edge RS is continued while the subject vehicle Am travels on the edge lane Lne, the repetition of the acceleration in the lateral direction is less likely to occur even in a scene in which the multiple parallel traveling vehicles AL pass the subject vehicle Am. Therefore, comfortable autonomous driving can be provided to the driver.

In the first embodiment, when the adjacent lanes Lna are present on both left and right sides of the subject vehicle lane Lns, the travel setting control unit 79 performs the offset control from the reference position Pc to the left and right according to the presence of the parallel traveling vehicle AL traveling on each adjacent lane Lna. According to the above description, since the distance Ds between the parallel traveling vehicle AL and the subject vehicle Am is ensured, it is possible to reduce the uneasiness of the driver in the autonomous driving period, in particular, in a case where the driver is monitoring the periphery at any time.

Further, in the first embodiment, since a traveling position of another vehicle traveling in front of or behind the subject vehicle Am is taken into consideration, smooth offset control can be performed. Therefore, unnecessary movement in the lateral direction due to the offset control can be limited. As a result, the acceleration in the lateral direction that is likely to be troublesome for the driver is reduced, and thus the convenience of autonomous driving can be improved.

In the first embodiment, when the traveling position of the other vehicle traveling in front of or behind the subject vehicle Am deviates from the reference position Pc in the lateral direction beyond a predetermined threshold, the offset control is canceled. In this way, when the traveling position of the preceding vehicle or the following vehicle deviates largely from the center of the subject vehicle lane Lns, there is a high possibility that a risk element that makes it difficult to continue the autonomous traveling control is present in front of or behind the subject vehicle Am. Therefore, by canceling the offset control, even if the driver performs a driving takeover due to the risk element, the driver can stably respond to the driving takeover in the center of the subject vehicle lane Lns.

In the first embodiment, when traffic congestion in the periphery of the subject vehicle Am is recognized, the offset control is interrupted. Therefore, in a scene in which the subject vehicle Am travels in the traffic congestion by autonomous driving, the occurrence frequency of acceleration in the lateral direction that is troublesome for the driver can be reduced. As a result, the driver feels comfortable in the autonomous driving period, and thus the convenience of autonomous driving can be improved.

In the first embodiment, the control switching unit 78 switches between the driving assistance control with a periphery monitoring obligation by the driver and the autonomous traveling control with no periphery monitoring obligation by the driver. The offset control is also performed in the driving assistance period in which the subject vehicle Am is traveling under the driving assistance control. Therefore, in a scene in which the driver does not see the periphery of the subject vehicle Am, since the distance Ds between the parallel traveling vehicle AL and the subject vehicle Am can be ensured, the uneasiness of the driver can be reduced.

In the first embodiment, when the entry into the traffic congestion is recognized in the driving assistance period with the offset control, the travel setting control unit 79 terminates the offset control before switching from the driving assistance control to the autonomous traveling control. By setting a termination timing of the offset control in this way, the offset control can be canceled in a state in which the driver is monitoring the periphery of the subject vehicle Am. As a result, the movement in the lateral direction toward the center of the lane that accompanies the cancellation of the offset control is less likely to make the driver feel uncomfortable.

Further, in the first embodiment, when the entry into the traffic congestion is recognized in the driving assistance period with the offset control, the offset control is continued until the switching from the driving assistance control to the autonomous traveling control is completed. That is, after the subject vehicle Am shifts to low-speed traveling due to the traffic congestion, the offset control is terminated. By setting the termination timing of the offset control in this way, it is less likely for the driver to recognize the acceleration in the lateral direction that accompanies the cancellation of the offset control. As a result, comfortable autonomous driving can be provided to the driver.

In the first embodiment, when the driver input that instructs the shift to the autonomous traveling control is recognized in the driving assistance period with the offset control, the travel setting control unit 79 terminates the offset control before switching from the driving assistance control to the autonomous traveling control. According to the above description, the offset control can be canceled in a state in which the driver is monitoring the periphery of the subject vehicle Am. As a result, the movement in the lateral direction that accompanies the cancellation of the offset control is less likely to make the driver feel uncomfortable.

Further, in an information presentation pattern according to the first embodiment, based on the recognition of the driver input that instructs the shift to the autonomous traveling control, the notification request unit 73 requests the HCU 100 to issue the offset termination notification and the control shift notification to the autonomous traveling control in parallel. Thus, when the offset termination notification and the control shift notification are issued together, the driver can easily recognize an entire image of a process for shifting from the driving assistance control to the autonomous traveling control. Such easy-to-understand notifications can further improve the convenience of autonomous driving.

Further, in another information presentation pattern according to the first embodiment, when the driver input that instructs the shift to the autonomous traveling control is recognized, the notification request unit 73 requests the HCU 100 to issue the offset termination notification. Thereafter, based on the termination of the offset control, the notification request unit 73 requests the HCU 100 to issue the control shift notification to the autonomous traveling control. As described above, when the offset termination notification and the control shift notification are sequentially issued, the driver can easily recognize a control state of the autonomous driving in the subject vehicle Am. As a result, the convenience of autonomous driving can be further improved.

In the first embodiment, the parallel traveling vehicle AL corresponds to the “other vehicle”. The automated driving ECU 50b corresponds to an “autonomous driving control device”, the travel setting control unit 79 corresponds to an “offset control unit”, the presentation control unit 88 corresponds to a “notification control unit”, and the HCU 100 corresponds to a “presentation control device”.

### Second Embodiment

A second embodiment of the present disclosure shown in FIGS. 1 to 3 and FIGS. 8 to 10 is a modification of the first embodiment. In the second embodiment, a process for canceling offset control in an autonomous traveling period is omitted. The HCU 100 according to the second embodiment issues an offset notification in an autonomous traveling period with no periphery monitoring obligation by a driver, and cancels the offset notification in a driving assistance period with a periphery monitoring obligation by the driver.

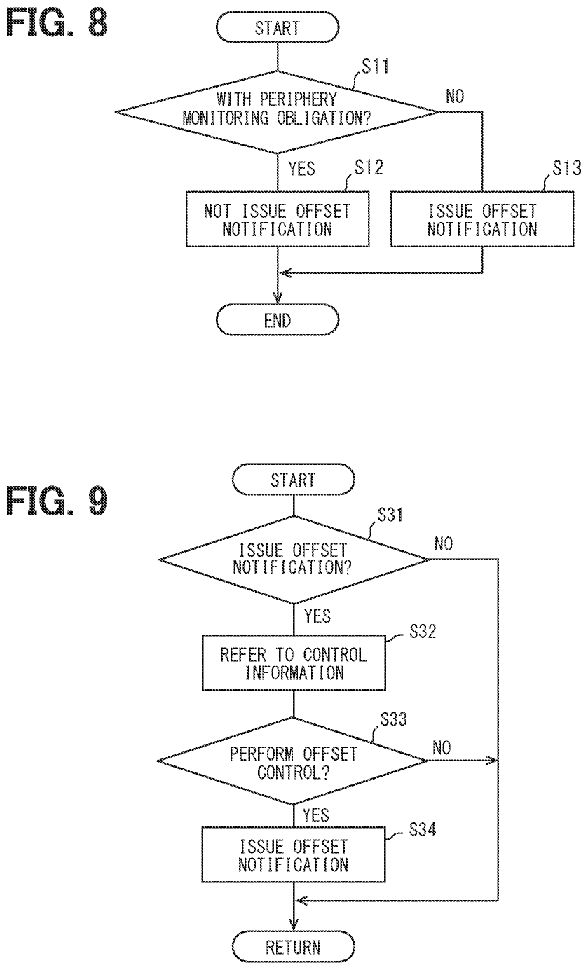

The presentation control unit 88 (see FIG. 3) performs a notification switching process (see FIG. 8) for switching the validity and invalidity of the offset notification and a notification issuing process (see FIG. 9) for issuing the offset notification in the autonomous traveling period with no periphery monitoring obligation. The notification switching process and the notification issuing process are started based on the autonomous driving function being activated in the automated driving system 50, and are continuously performed until the autonomous driving function is stopped.

When the autonomous driving function is in an operation state in the automated driving system 50 by the notification switching process (see FIG. 8), the presentation control unit 88 determines whether the traveling control performed by the autonomous driving function has the periphery monitoring obligation, based on the information recognized by the monitoring obligation recognition unit 84 (S11). In response to determining that there is a periphery monitoring obligation by the driver (S11: YES), the presentation control unit 88 sets the offset notification not to be issued (S12). On the other hand, in response to determining that there is no periphery monitoring obligation by the driver (S11: NO), the presentation control unit 88 sets the offset notification to be issued (S13).

The presentation control unit 88 issues the offset notification in the autonomous traveling period with no periphery monitoring obligation by the notification issuing process (see FIG. 9). The presentation control unit 88 refers to a result of the notification switching process and determines whether to set the offset notification to be issued (S31). When the offset notification is set to be not issued (S31: NO), the presentation control unit 88 omits the offset notification.

On the other hand, when the offset notification is set to be not issued (S31: YES), the presentation control unit 88 refers to control information related to the offset control recognized by the offset control recognition unit 83 (see FIG. 3) (S32), and determines whether the offset notification is to be issued (S33). When the offset control is not performed and the offset control is not to be performed (S33: NO), the presentation control unit 88 does not issue the offset notification.

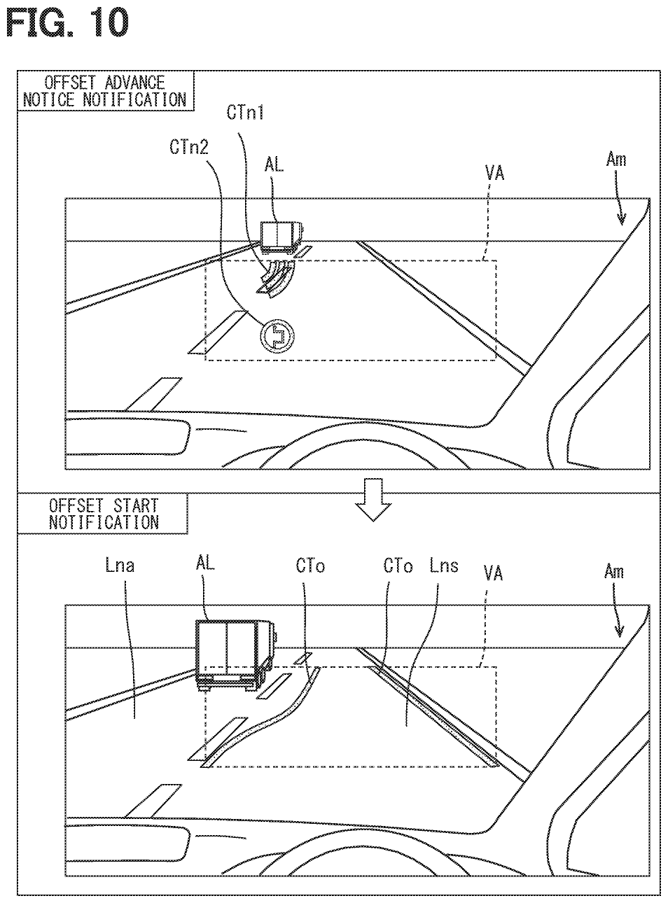

On the other hand, when the offset control is performed or when the offset control is to be performed (S33: YES), the presentation control unit 88 issues the offset notification based on the offset control information recognized by the offset control recognition unit 83 (S34). The presentation control unit 88 issues an offset advance notice notification (refer to an upper part of FIG. 10) and an offset start notification (refer to a lower part of FIG. 10) as the offset notification.

The presentation control unit 88 starts the offset advance notice notification a predetermined time before the offset control by the automated driving ECU 50b is started. In the offset advance notice notification, advance notice icons CTn1 and CTn2 for noticing the start of the offset control in advance are displayed as virtual images in the angle of view VA. The advance notice icons CTn1 and CTn2 are non-superimposed contents displayed at predetermined positions in the angle of view VA.

The presentation control unit 88 starts the offset start notification at a timing when a start point of the offset control enters the angle of view VA of the HUD 23. In the offset start notification, when the advance notice icons CTn1 and CTn2 are not displayed, the offset content CTo is displayed as a virtual image in the angle of view VA. The offset content CTo is a superimposed content superimposed on a road surface in front of the subject vehicle lane Lns, and notices in advance movement in the lateral direction of the subject vehicle Am in a direction away from the parallel traveling vehicle AL of the adjacent lane Lna.

In the second embodiment described above, the same effect as in the first embodiment can also be obtained, and the troublesomeness related to the offset control can also be reduced. More specifically, in the second embodiment, in a case in which there is no periphery monitoring obligation by the driver, even when the driver does not see the periphery of the subject vehicle, the driver can recognize a reason for the occurrence of the acceleration in the lateral direction due to the offset control through an offset notification related to the offset control. On the other hand, in a case in which there is a periphery monitoring obligation by the driver, since the driver is seeing the periphery of the subject vehicle, the driver can recognize the offset control and is less likely to feel uncomfortable about the acceleration in the lateral direction even when there is no offset notification. As a result, since the troublesomeness related to the offset notification can be reduced, the convenience of autonomous driving can be improved.

In the offset control by the automated driving system 50 according to the second embodiment, the offset control amount Wos (see FIG. 4) is set so as not to be noticed by the driver. Therefore, in a case in which there is a periphery monitoring obligation, since the driver is seeing the periphery of the subject vehicle, the driver is less likely to feel uneasy about a behavior of the vehicle due to the offset control even when information related to the offset control is not transmitted. On the other hand, in a case in which there is no periphery monitoring obligation, since even a slight offset may make the driver feel uneasy, information relating to the offset is notified to the driver or the like. As a result, it is possible to give a sense of security to the driver.

### Third Embodiment

A third embodiment of the present disclosure is another modification of the first embodiment. In the third embodiment, the automated driving ECU 50b shown in FIGS. 1 to 3 can perform autonomous traveling of Level 4 at an autonomous driving level defined by the Society of Automotive Engineers. In the above-described autonomous driving period of autonomous driving Level 3, the driver has an obligation to respond to a driving takeover request from the automated driving system 50. Therefore, as a second task, while a device operation or the like is permitted, sleep is not permitted. On the other hand, in the autonomous driving period of autonomous driving Level 4, the driver has no obligation to respond to the driving takeover request from the automated driving system 50. Therefore, sleep is permitted as one of the second task.

In the automated driving ECU 50b according to the third embodiment, the driver recognition unit 72, the control switching unit 78, and the travel setting control unit 79 perform processes corresponding to the autonomous driving of Level 4.

The driver recognition unit 72 recognizes whether the driver is in a sleeping state based on the driver action information acquired from the information cooperation unit 82. The driver action information is generated by the driver action recognition unit 86 of the HCU 100 based on the driver status information output from the driver monitor 29. The driver action recognition unit 86 determines whether the driver is in the sleeping state based on, for example, a driving posture and an eye-opening degree of the driver. The driver action recognition unit 86 may acquire biological data such as a pulse rate, a blood pressure, and a body temperature of the driver from, for example, a wearable terminal worn by the driver, and may determine whether the driver is in the sleeping state. Further, the driver action recognition unit 86 may recognize a reclining state of a backrest of a driver's seat and determine that the driver is in the sleeping state when the backrest is tilted backward by a predetermined angle or more. The driver recognition unit 72 recognizes whether the driver is in the sleeping state by referring to a determination result of the driver action recognition unit 86 at least in the autonomous driving period of autonomous driving Level 4.

The control switching unit 78 further has a function of switching between Level 3 traveling control, which is the autonomous traveling control corresponding to autonomous driving Level 3, and Level 4 traveling control, which is autonomous traveling control corresponding to autonomous driving Level 4. As described above, the sleep of the driver is not permitted when the vehicle travels under Level 3 traveling control, and the sleep of the driver is permitted when the vehicle travels under Level 4 traveling control. As an example, when the subject vehicle Am enters a permitted area in which the autonomous driving of Level 4 is permitted, the control switching unit 78 shifts from Level 3 traveling control to Level 4 traveling control.

The travel setting control unit 79 restricts the execution of the offset control not only in an autonomous driving period in which the subject vehicle Am travels under Level 3 traveling control but also in an autonomous driving period in which the subject vehicle Am travels under Level 4 traveling control (S105 in FIG. 6: NO). When the driver recognition unit 72 determines that the driver is in the sleeping state in the autonomous driving period in which the subject vehicle Am travels under Level 4 traveling control, the travel setting control unit 79 determines that the stop state condition is established (S107: YES). In this case, the travel setting control unit 79 cancels the offset control (S110).

When it is determined that the driver is not in the sleeping state and another stop state condition is not established in the autonomous driving period in which the subject vehicle Am travels under Level 4 traveling control (S107: NO), the travel setting control unit 79 permits the execution of the offset control. The travel setting control unit 79 changes the offset control amount Wos (see FIG. 4), which is a movement amount in the lateral direction under the offset control, in accordance with the autonomous driving level, in the scheduled traveling line PRL (see FIG. 4) generated by the action determination unit 63. Specifically, the travel setting control unit 79 sets the offset control amount Wos when the subject vehicle Am travels under Level 4 traveling control to be smaller than the offset control amount Wos when the subject vehicle Am travels under Level 3 traveling control.

In the third embodiment described above, the same effect as in the first embodiment can also be obtained, and the troublesomeness related to the offset control can also be reduced. Specifically, in the third embodiment, the control switching unit 78 switches between Level 3 traveling control that does not permit the driver to sleep and Level 4 traveling control that permits the driver to sleep. The travel setting control unit 79 restricts the execution of the offset control in both of the autonomous driving period in which the subject vehicle Am travels under Level 3 traveling control and the autonomous driving period in which the subject vehicle Am travels under Level 4 traveling control. As a result, since the occurrence frequency of the acceleration in the lateral direction that is troublesome for the driver can be reduced while the subject vehicle Am travels at autonomous driving Level 4 in which the driver does not see the periphery of the subject vehicle Am, the troublesomeness related to the offset control can be reduced.

In addition, in the third embodiment, the offset control is canceled when the driver is in the sleeping state in the autonomous driving period in which the subject vehicle Am travels under Level 4 traveling control. According to the above description, when the driver is in the sleeping state, the acceleration in the lateral direction due to the offset control is less likely to occur. As a result, the driver can easily get a comfortable sleep, and thus the convenience of autonomous driving can be further improved. Furthermore, since the driver in the sleeping state does not see the periphery of the subject vehicle Am, it is less likely for the driver to feel fear of the large-sized parallel traveling vehicle AL. Therefore, the sense of security is less likely to decrease due to the cancellation of the offset control.

In the third embodiment, the offset control amount Wos when the subject vehicle Am travels under Level 4 traveling control is set to be smaller than the offset control amount Wos when the subject vehicle Am travels under Level 3 traveling control. In the autonomous driving period under Level 4 traveling control, a frequency at which the driver monitors the periphery is predicted to decrease compared to a period under Level 3 traveling control. Therefore, according to the adjustment in which the offset control amount Wos under Level 4 traveling control is set to be smaller than the offset control amount Wos under Level 3 traveling control, a balance between the comfort and the sense of security can be optimized in accordance with the automated driving level to be performed.

In the above third embodiment, Level 3 traveling control corresponds to “first traveling control”, and Level 4 traveling control corresponds to “second traveling control”.

### Other Embodiments

Although the multiple embodiments according to the present disclosure have been described above, the present disclosure is not construed as being limited to the above-mentioned embodiments, and can be applied to various embodiments and combinations within a scope not departing from the spirit of the present disclosure.

In Modification 1 of the second embodiment, the offset notification is also issued in the driving assistance period with a periphery monitoring obligation by the driver. In the HCU 100 according to Modification 1, the presentation control unit 88 makes an offset notification in a case where there is a periphery monitoring obligation by the driver to be weaker than an offset notification in a case where there is no periphery monitoring obligation by the driver. As an example, when there is a periphery monitoring obligation, the presentation control unit 88 issues only one of the offset advance notice notification and the offset start notification. As another example, when there is no periphery monitoring obligation, the presentation control unit 88 issues an offset notification using a combination of display and voice, and when there is a periphery monitoring obligation, the presentation control unit 88 cancels the offset notification by voice and issues the offset notification only by display.

As in Modification 1 described above, even when the offset notification is weakened, since the driver is seeing the periphery of the subject vehicle, the driver in the driving assistance period can recognize the offset control and is less likely to feel uncomfortable about the acceleration in the lateral direction. As a result, as in the second embodiment, since the troublesomeness related to the offset notification can be reduced, the convenience of autonomous driving can be improved.

In Modification 2 of the first embodiment, a process for determining whether to cancel the offset notification according to the driver status (see S107 and S110 in FIG. 6) is omitted. Accordingly, the travel setting control unit 79 substantially cancels the offset control in the autonomous traveling period with no periphery monitoring obligation by the driver. As described above, the process for canceling the offset control in the autonomous traveling period may be performed under a predetermined condition or may be performed normally regardless of other conditions.

In Modification 3 of the above-described embodiment, a process for changing the contents of the offset control according to the position of the subject vehicle lane Lns is omitted. In Modification 4 of the above-described embodiment, a process for canceling the offset control when the vehicle travels in traffic congestion is omitted. Further, in Modification 5 of the above-described embodiment, a process for canceling the offset control based on a driver trigger is omitted.

In Modification 6 of the above-described embodiment, when the driver input that instructs the shift to the autonomous traveling control is recognized in the driving assistance period with the offset control, the travel setting control unit 79 continues the offset control until the switching from the driving assistance control to the autonomous traveling control is completed. According to the above description, since the offset control is canceled after the subject vehicle Am shifts to the low-speed traveling associated with traffic congestion, it is less likely for the driver to recognize the acceleration in the lateral direction due to the cancellation of the offset control. Therefore, comfortable autonomous driving can be provided to the driver.

In Modification 7 of the above embodiment, functions of the driving assistance ECU 50a and the automated driving ECU 50b are provided by one autonomous driving ECU. That is, the function of the driving assistance ECU 50a is implemented in the automated driving ECU 50b according to Modification 7.

In Modification 8 of the above embodiment, functions of the driving assistance ECU 50a, the automated driving ECU 50b, and the HCU 100 are provided by one integrated ECU. In Modification 8, the integrated ECU corresponds to the “autonomous driving control device” and the “presentation control device”.

In Modification 9 of the above-described embodiment, a function of the driver action recognition unit 86 is implemented in the driving assistance ECU 50a. In Modification 10 of the above-described embodiment, the function of the driver action recognition unit 86 is implemented in the control unit of the driver monitor 29. In Modifications 9 and 10, the driver status information and the driver action information are provided from the driving assistance ECU 50a or the driver monitor 29 to the automated driving ECU 50b and the HCU 100.

In Modification 11 of the above embodiment, the automated driving ECU can perform autonomous driving at Level 4 or higher. The automated driving ECU according to Modification 11 can also be applied to the process for canceling the offset control and the process for canceling the offset notification. In Modification 11, substantially the same offset control is performed in autonomous driving periods of Level 3 and Level 4.

In Modification 12 of the third embodiment, the travel setting control unit 79 cancels the offset control when the driver is not in the sleeping state in the autonomous driving period in which the subject vehicle Am travels under Level 4 traveling control. In other words, the travel setting control unit 79 permits execution of the offset control when the driver is in the sleeping state. In Modification 12, when the driver is in the sleeping state and the vehicle travels under Level 4 traveling control, the possibility of excessive approach to the parallel traveling vehicle AL is reduced by performing the offset control. As described above, smooth traveling in the sleeping state is realized.

In Modification 13 of the above-described embodiment, it is determined whether to perform the offset control when the subject vehicle Am travels under Level 3 traveling control and Level 4 traveling control according to a vehicle type of the subject vehicle Am on which the automated driving system 50 is mounted. Specifically, when the subject vehicle Am on which the automated driving system 50 is mounted is a large-sized vehicle defined in advance, a function of the offset control is invalidated. On the other hand, when the automated driving system 50 is a passenger car, the function of the offset control is activated. For example, the automated driving ECU 50b acquires information indicating the vehicle type of the subject vehicle Am in an initial startup process after mounting work on the vehicle, and activates or deactivates the function of the offset control function according to the vehicle type. Such a process may be executed in each startup process of the automated driving ECU 50b after a power supply of the subject vehicle Am is switched to an on-state. According to Modification 13, it is possible to prevent the offset control from being performed in a vehicle in which the offset control is not desirable. In addition, the automated driving ECU 50b and the automated driving system 50 having the same type can be mounted on multiple types of vehicles.

In the above embodiments, functions provided by the autonomous driving ECUs and the HCU can be provided by software and hardware for executing the software, only software, only hardware, or a complex combination of the hardware and the software. Moreover, when the above functions are provided by an electronic circuit as hardware, each function may also be provided by a digital circuit which includes multiple logic circuits, or an analog circuit.

Each processing unit according to the above-described embodiments may be individually mounted on a printed circuit board, or may be mounted on an application specific integrated circuit (ASIC), an FPGA, or the like. A form of a storage medium (a continuous tangible computer storage medium, a non-transitory tangible storage medium) that stores various programs and the like may also be appropriately changed. Further, the storage medium is not limited to a configuration provided on a circuit board, and may be provided in a form of a memory card or the like, inserted into a slot portion, and electrically connected to a control circuit of the autonomous driving ECUs or the HCU. The storage medium may be an optical disk, a hard disk drive, or the like from which programs are copied to the automated driving ECUs or the HCU.

The vehicle on which the autonomous driving system and the HMI system are mounted is not limited to a general passenger vehicle for private use, and may be a rental vehicle, a manned taxi vehicle, a ride-sharing vehicle, a cargo vehicle, a bus, or the like. The vehicle on which the autonomous driving system and the HMI system are mounted may be a right-hand drive vehicle or a left-hand drive vehicle. Further, a traffic environment in which the vehicle travels may be a traffic environment on the assumption of left-hand traffic or a traffic environment on the assumption of right-hand traffic. Autonomous driving control and information presentation according to the present disclosure may be optimized as appropriate in accordance with the Road Traffic Law of each country and region, a steering wheel position of the vehicle, and the like.

The control unit and the method thereof described in the present disclosure may be implemented by a dedicated computer constituting a processor programmed to execute one or multiple functions embodied by a computer program. Alternatively, the device and the method thereof described in the present disclosure may be implemented by a dedicated hardware logic circuit. Alternatively, the device and the method thereof described in the present disclosure may be implemented by one or more dedicated computers configured by a combination of a processor executing a computer program and one or more hardware logic circuits. The computer program may be stored in a computer-readable non-transitory tangible recording medium as an instruction to be executed by the computer.

Here, the process of the flowchart or the flowchart described in this application includes a plurality of sections (or steps), and each section is expressed as, for example, S11. Further, each section may be divided into several subsections, while several sections may be combined into one section. Furthermore, each section thus configured may be referred to as a device, module, or means.

1. An automated driving control device comprising:
a control switching unit configured to perform switching between a driving assistance control with a periphery monitoring obligation of a driver and an autonomous traveling control without the periphery monitoring obligation of the driver; and
an offset control unit configured to
execute an offset control that moves a reference position in a left direction or a right direction for causing a traveling position of a subject vehicle traveling in a subject vehicle lane to move away from a parallel traveling vehicle traveling in an adjacent lane during a driving assistance period in which the subject vehicle travels with the driving assistance control, and
limit execution of the offset control during an automated driving period in which the subject vehicle travels with the autonomous traveling control.

2. The automated driving control device according to claim 1, further comprising:
a driver recognition unit configured to recognize a driver state of the driver,
wherein
the offset control unit is configured to determine whether to limit the execution of the offset control during the automated driving period, according to the driver state.

3. The automated driving control device according to claim 2, wherein
the driver recognition unit is configured to recognize a poor physical condition of the driver during the automated driving period, and
the offset control unit cancels the offset control when the driver recognition unit has recognized the poor physical condition.

4. An automated driving control device comprising:
a control switching unit configured to perform switching between a driving assistance control with a periphery monitoring obligation of a driver and an autonomous traveling control without the periphery monitoring obligation of the driver;
an offset control unit configured to
execute an offset control that moves a traveling position of the subject vehicle in a left direction or a right direction with respect to a reference position in a subject vehicle lane during a driving assistance period in which the subject vehicle travels with the driving assistance control, and
limit execution of the offset control during an automated driving period in which the subject vehicle travels with the autonomous traveling control;
a driver recognition unit configured to recognize a driver state of the driver,
wherein
the driver recognition unit is configured to recognize a poor physical condition of the driver during the automated driving period, and
the offset control unit is configured to
determine whether to limit the execution of the offset control during the automated driving period, according to the driver state, and
cancel the offset control when the driver recognition unit has recognized the poor physical condition.

5. The automated driving control device according to claim 2, wherein
the driver recognition unit is configured to recognize, as the driver state, whether the driver is monitoring a periphery of the subject vehicle during the automated driving period,
the offset control unit cancels the offset control when the driver is not monitoring the periphery, and
the offset control unit permits the execution of the offset control when the driver is monitoring the periphery.

6. The automated driving control device according to claim 2, wherein
the driver recognition unit is configured to recognize, as the driver state, a driver action of the driver during the automated driving period,
the driver action is different from driving, and
the offset control unit is configured to determine whether to cancel the offset control according to the driver action different from the driving.

7. The automated driving control device according to claim 6, wherein
the offset control unit cancels the offset control when the driver is performing reading of a character, and
the driver action includes the reading.

8. The automated driving control device according to claim 1, wherein
the control switching unit performs switching between a first traveling control and a second traveling control,
the autonomous traveling control includes the first traveling control and the second traveling control,
the first traveling control does not permit sleep of the driver,
the second traveling control permits the sleep of the driver, and
the offset control unit is configured to limit the execution of the offset control for each of the automated driving period in which the subject vehicle travels with the first traveling control and the automated driving period in which the subject vehicle travels with the second traveling control.

9. The automated driving control device according to claim 8, wherein
a second movement amount is a lateral direction movement amount of the offset control when the subject vehicle travels with the second traveling control,
a first movement amount is a lateral direction amount of the offset control when the subject vehicle travels with the first traveling control, and
the offset control unit is configured to set the second movement amount to be smaller than the first movement amount.

10. An automated driving control device comprising:
a control switching unit configured to perform switching between a driving assistance control with a periphery monitoring obligation of a driver and an autonomous traveling control without the periphery monitoring obligation of the driver; and
an offset control unit configured to
execute an offset control that moves a reference position of a subject vehicle in a left direction or a right direction with respect to a reference position for moving the subject vehicle traveling in a subject vehicle lane during a driving assistance period in which the subject vehicle travels with the driving assistance control, and
limit execution of the offset control during an automated driving period in which the subject vehicle travels by the autonomous traveling control,
wherein
the control switching unit performs switching between a first traveling control and a second traveling control,
the autonomous traveling control includes the first traveling control and the second traveling control,
the first traveling control does not permit sleep of the driver,
the second traveling control permits the sleep of the driver,
the offset control unit is configured to limit the execution of the offset control for each of the automated driving period in which the subject vehicle travels with the first traveling control and the automated driving period in which the subject vehicle travels with the second traveling control,
a second movement amount is a lateral direction movement amount of the offset control when the subject vehicle travels with the second traveling control,
a first movement amount is a lateral direction amount of the offset control when the subject vehicle travels with the first traveling control, and
the offset control unit is configured to set the second movement amount to be smaller than the first movement amount.

11. The automated driving control device according to claim 10, further comprising:
a driver recognition unit configured to recognize a driver state of the driver,
wherein
the offset control unit is configured to determine whether to limit the execution of the offset control during the automated driving period, according to the driver state.

12. The vehicle display system according to claim 11, wherein
the driver recognition unit is configured to recognize, as the driver state, whether the driver is monitoring a periphery of the subject vehicle during the automated driving period,
the offset control unit cancels the offset control when the driver is not monitoring the periphery, and
the offset control unit permits the execution of the offset control when the driver is monitoring the periphery.

13. The automated driving control device according to claim 11, wherein
the driver recognition unit is configured to recognize a poor physical condition of the driver during the automated driving period, and
the offset control unit cancels the offset control when the driver recognition unit has recognized the poor physical condition.

14. The automated driving control device according to claim 11, wherein
the driver recognition unit is configured to recognize, as the driver state, a driver action of the driver during the automated driving period,
the driver action is different from driving, and
the offset control unit is configured to determine whether to cancel the offset control according to the action different from the driving.

15. The automated driving control device according to claim 14, wherein
the offset control unit cancels the offset control when the driver performs reading of a character, and
the driver action includes the reading.

16. The automated driving control device according to claim 8, wherein
the offset control unit cancels the offset control when the driver is sleeping during the automated driving period in which the subject vehicle travels with the second traveling control.

17. The automated driving control device according to claim 8, wherein
the offset control unit cancels the offset control when the driver is not sleeping during the automated driving period in which the subject vehicle travels with the second traveling control.

18. A non-transitory computer-readable storage medium storing an automated driving control program causing at least one processor to:
execute an offset control that requires an periphery monitoring obligation of a driver and moves a traveling position of a subject vehicle in a left direction or a right direction with respect to a reference position for causing the subject vehicle traveling in a subject vehicle lane to move away from a parallel traveling vehicle traveling in an adjacent lane during a driving assistance period in which the subject vehicle travels with the driving assistance control with a periphery monitoring obligation of the driver; and
limit the execution of the offset control during an automated driving period in which the subject vehicle travels with the autonomous traveling control without the periphery monitoring obligation of the driver.

19. A non-transitory computer-readable storage medium storing an automated driving control program causing at least one processor to:
execute an offset control that requires an periphery monitoring obligation of a driver and moves a traveling position of a subject vehicle in a left direction or a right direction with respect to a reference position for moving the subject vehicle traveling in a subject vehicle lane during a driving assistance period in which the subject vehicle travels with the driving assistance control with a periphery monitoring obligation of a driver;
recognize a driver state of the driver;
recognize a poor physical condition of the driver during an automated driving period in which the subject vehicle travels with the autonomous traveling control without the periphery monitoring obligation of the driver;
limit execution of the offset control during the automated driving period;
determine whether to limit the execution of the offset control based on the driver state; and
cancel the offset control when having recognized the poor physical condition.

20. A non-transitory computer-readable storage medium storing an automated driving control program causing at least one processor to:
execute an offset control that requires an periphery monitoring obligation of a driver and moves a traveling position of a subject vehicle in a left direction or a right direction with respect to a reference position for moving the subject vehicle traveling in a subject vehicle lane during a driving assistance period in which the subject vehicle travels with the driving assistance control with a periphery monitoring obligation of a driver;
limit execution of the offset control during an automated driving period in which the subject vehicle travels with the autonomous traveling control without the periphery monitoring obligation of the driver;
perform switching between a first traveling control and a second traveling control, wherein the autonomous traveling control includes the first traveling control and the second traveling control, the first traveling control does not permit sleep of the driver and the second traveling control permits the sleep of the driver;
limit the execution of the offset control for each of the automated driving period in which the subject vehicle travels with the first traveling control and the automated driving period in which the subject vehicle travels with the second traveling control; and
set a second movement amount to be smaller than a first movement amount,
wherein
the second movement amount is a lateral direction movement amount of the offset control when the subject vehicle travels with the second traveling control, and
the first movement amount is a lateral direction amount of the offset control when the subject vehicle travels with the first traveling control.

21. An automated driving control device capable of performing automated driving without a periphery monitoring obligation of a driver, the device comprising:
a lane recognition unit configured to recognize a subject vehicle lane in which a subject vehicle travels among a plurality of lanes when the subject vehicle travels by the automated driving on a road including the plurality of lanes; and
an offset control unit configured to
execute an offset control that moves a traveling position of a subject vehicle in a left direction or a right direction with respect to a reference position for causing the subject vehicle traveling by automated driving in the subject vehicle lane to move away from a parallel traveling vehicle traveling in an adjacent lane, and
change content of the offset control according to a position of the subject vehicle lane among the plurality of lanes,
wherein
the lane recognition unit is configured to recognize whether an edge lane that is an outermost lane of the road among the plurality of lanes, and
the offset control unit is configured to continuously execute the offset control that causes the subject vehicle to move toward an outside of the road even when the parallel traveling vehicle does not exist, in a case where the edge lane is the subject vehicle lane.

22. The automated driving control device according to claim 21, wherein
the offset control unit executes the offset control that causes the subject vehicle to move away from the parallel traveling vehicle traveling in the adjacent lane when the subject vehicle lane is a center lane different from the edge lane among the plurality of lanes.

23. The automated driving control device according to claim 21, wherein
the offset control unit executes the offset control that moves the traveling position in the right direction or the left direction with respect to the reference position based on an existence of the parallel traveling vehicle traveling in the adjacent lane when both of a left lane and right lane with respect to the subject vehicle exist as the adjacent lane.

24. A non-transitory computer-readable storage medium storing an automated driving control program that is capable of performing automated driving without a periphery monitoring obligation of a driver and causes at least one processor to:
recognize a subject vehicle lane in which a subject vehicle travels among a plurality of lanes when the subject vehicle travels by automated driving on a road including the plurality of lanes;
recognize whether the subject vehicle lane is an edge lane that is an outermost lane of the road among the plurality of lanes;
execute an offset control that moves a traveling position of a subject vehicle in a left direction or a right direction with respect to a reference position for causing the subject vehicle traveling by automated driving in the subject vehicle lane to move away from a parallel traveling vehicle traveling in an adjacent lane;
change content of the offset control according to a position of the subject vehicle lane among the plurality of lanes; and
continuously execute the offset control that causes the subject vehicle to move toward an outside of the road even when the parallel traveling vehicle does not exist, in a case where the edge lane is the subject vehicle lane.

25. An automated driving control device capable of performing automated driving without a periphery monitoring obligation of a driver, the device comprising:
a different vehicle recognition unit configured to recognize a traveling position in a lateral direction in a subject vehicle lane in which the subject vehicle and a different vehicle travel; and
an offset control unit configured to execute an offset control that moves a traveling position of the subject vehicle in a left direction or a right direction with respect to a reference position for causing the subject vehicle traveling by automated driving in the subject vehicle lane to move away from a parallel traveling vehicle traveling in an adjacent lane, and
change content of the offset control according to a traveling position of the different vehicle in the subject vehicle lane.

26. The automated driving control device according to claim 25, wherein
the offset control unit cancels the offset control when a difference in the lateral direction between the traveling position of the different vehicle and the reference position exceeds a predetermined threshold.

27. A non-transitory computer-readable storage medium storing an automated driving control program that is capable of performing automated driving without a periphery monitoring obligation of a driver and causes at least one processor to:
execute an offset control that moves a traveling position of a subject vehicle in a left direction or a right direction with respect to a reference position for causing the subject vehicle traveling by automated driving in a subject vehicle lane to move away from a parallel traveling vehicle traveling in an adjacent lane;
recognize a lateral traveling position of the different vehicle in the subject vehicle lane in which the different vehicle travels; and
change content of the offset control according to the traveling position of the different vehicle in the subject vehicle lane.

28. An automated driving control device capable of performing automated driving without a periphery monitoring obligation of a driver, the device comprising:
a traffic congestion recognition unit configured to recognize a traffic congestion in a periphery of a subject vehicle; and
an offset control unit configured to
execute an offset control that moves a traveling position of the subject vehicle in a left direction or a right direction with respect to a reference position for causing the subject vehicle in a subject vehicle lane to move away from a parallel traveling vehicle traveling in an adjacent lane when the subject vehicle travels by automated driving, and
cancel the offset control when the traffic congestion recognition unit has recognized the traffic congestion in the periphery of the subject vehicle.

29. The automated driving control device according to claim 28, further comprising:
a control switching unit configured to perform switching between a driving assistance control with a periphery monitoring obligation of a driver and an autonomous traveling control without the periphery monitoring obligation of the driver,
wherein
the offset control unit executes the offset control even during a driving assistance period in which the subject vehicle travels by the driving assistance control.

30. The automated driving control device according to claim 29, further comprising:
an input recognition unit configured to recognize a driver input that provides an instruction of a shift from the driving assistance control to the autonomous traveling control,
wherein
the offset control unit ends the offset control before the control switching unit performs switching from the driving assistance control to the autonomous traveling control, when the input recognition unit has recognized the driver input during the driving assistance period with the offset control.

31. The automated driving control device according to claim 30, further comprising:
a notification request unit configured to request a presentation control device to perform a notification related to automated driving,
wherein
the presentation control device presents information to the driver, and
the notification request unit is configured to request the presentation control device to parallelly perform an end notification of the offset control and a shift notification of a shift to the autonomous traveling control based on recognition of the driver input by the input recognition unit.

32. The automated driving control device according to claim 30, further comprising:
a notification request unit configured to request a presentation control device to perform a notification related to automated driving,
wherein
the presentation control device presents information to the driver,
the notification request unit requests the presentation control device to perform an end notification of the offset control based on recognition of the driver input by the input recognition unit, and
the notification request unit requests the presentation control device to perform a shift notification of a shift to the autonomous traveling control based on an end of the offset control.

33. An automated driving control device capable of performing automated driving without periphery monitoring obligation of a driver, the device comprising:
a traffic congestion recognition unit configured to recognize a traffic congestion in a periphery of a subject vehicle;
an offset control unit configured to
execute an offset control that moves a traveling position of the subject vehicle in a left direction or a right direction with respect to a reference position in a subject vehicle lane when the subject vehicle travels by automated driving, and
cancel the offset control when the traffic congestion recognition unit has recognized the traffic congestion in the periphery of the subject vehicle;
a control switching unit configured to perform switching between a driving assistance control with a periphery monitoring obligation of a driver and an autonomous traveling control without the periphery monitoring obligation of the driver;
an input recognition unit configured to recognize a driver input that provides an instruction of a shift from the driving assistance control to the autonomous traveling control; and
a notification request unit configured to request a presentation control device to perform a notification related to automated driving,
wherein
the presentation control device presents information to the driver,
the offset control unit executes the offset control even during a driving assistance period in which the subject vehicle travels by the driving assistance control,
the offset control unit ends the offset control before the control switching unit performs switching from the driving assistance control to the autonomous traveling control, when the input recognition unit has recognized the driver input during the driving assistance period with the offset control, and
the notification request unit is configured to request the presentation control device to parallelly perform an end notification of the offset control and a shift notification of a shift to the autonomous traveling control based on recognition of the driver input by the input recognition unit.

34. An automated driving control device capable of performing automated driving without a periphery monitoring obligation of a driver, the device comprising:
a traffic congestion recognition unit configured to recognize a traffic congestion in a periphery of a subject vehicle;
an offset control unit configured to
execute an offset control that moves a traveling position of the subject vehicle in a left direction or a right direction with respect to a reference position in a subject vehicle lane when the subject vehicle travels by automated driving, and
cancel the offset control when the traffic congestion recognition unit has recognized the traffic congestion in the periphery of the subject vehicle;
a control switching unit configured to perform switching between a driving assistance control with a periphery monitoring obligation of a driver and an autonomous traveling control without the periphery monitoring obligation of the driver;
an input recognition unit configured to recognize a driver input that provides an instruction of a shift from the driving assistance control to the autonomous traveling control; and
a notification request unit configured to request a presentation control device to perform a notification related to automated driving,
wherein
the presentation control device presents information to the driver,
the offset control unit executes the offset control even during a driving assistance period in which the subject vehicle travels by the driving assistance control,
the offset control unit ends the offset control before the control switching unit performs switching from the driving assistance control to the autonomous traveling control, when the input recognition unit has recognized the driver input during the driving assistance period with the offset control,
the notification request unit requests the presentation control device to perform an end notification of the offset control based on recognition of the driver input by the input recognition unit, and
the notification request unit requests the presentation control device to perform a shift notification of a shift to the autonomous traveling control based on an end of the offset control.

35. The automated driving control device according to claim 29, wherein
the control switching unit performs switching from the driving assistance control to the autonomous traveling control when the traffic congestion recognition unit has recognized that subject vehicle enters a traffic congestion, and
wherein
the offset control unit ends the offset control before the control switching unit performs switching from the driving assistance control to the autonomous traveling control, when the traffic congestion recognition unit has recognized that the subject vehicle enters the traffic congestion during the driving assistance period with the offset control.

36. The automated driving control device according to claim 29, wherein
the control switching unit performs switching form the driving assistance control to the autonomous traveling control when the traffic congestion recognition unit has recognized that the subject vehicle enters a traffic congestion, and
wherein
the offset control unit continues the offset control before the control switching unit completes the switching from the driving assistance control to the autonomous traveling control, when the traffic congestion recognition unit has recognized that the subject vehicle enters the traffic congestion during the driving assistance period with the offset control.

37. A non-transitory computer-readable storage medium storing an automated driving control program that is capable of performing automated driving without a periphery monitoring obligation of a driver and causes at least one processor to:
execute an offset control that moves a traveling position of a subject vehicle in a left direction or a right direction with respect to a reference position for causing the subject vehicle to move away from a parallel traveling vehicle traveling in an adjacent lane, when the subject vehicle travels with automated driving; and
cancel the offset control when having recognized the traffic congestion in a periphery of the subject vehicle.

38. A non-transitory computer-readable storage medium storing an automated driving control program that is capable of performing automated driving without a periphery monitoring obligation of a driver and causes at least one processor to:
perform switching between a driving assistance control with a periphery monitoring obligation of a driver and an autonomous traveling control without the periphery monitoring obligation of the driver;
recognize a driver input that provides an instruction of a shift from the driving assistance control to the autonomous traveling control;
execute an offset control that moves a traveling position of a subject vehicle in a left direction or a right direction with respect to a reference position, when the subject vehicle travels with automated driving;
cancel the offset control when having recognized the traffic congestion in a periphery of the subject vehicle;
execute the offset control during a driving assistance period in which the subject vehicle travels with the driving assistance control;
end the offset control before the switching from the driving assistance control to the autonomous traveling control when having recognized the driver input during the driving assistance period with the offset control;
request a presentation control device to perform a notification related to automated driving; and
request the presentation control device to parallelly perform an end notification of the offset control and a shift notification to the autonomous traveling control based on recognition of the driver input,
wherein
the presentation control device presents information to the driver.

39. A non-transitory computer-readable storage medium storing an automated driving control program that is capable of performing automated driving without a periphery monitoring obligation of a driver and causes at least one processor to:
perform switching between a driving assistance control with a periphery monitoring obligation of a driver and an autonomous traveling control without the periphery monitoring obligation of the driver;
recognize a driver input that provides an instruction of a shift from the driving assistance control to the autonomous traveling control;
execute an offset control that moves a traveling position of a subject vehicle in a left direction or a right direction with respect to a reference position, when the subject vehicle travels with automated driving;
cancel the offset control when having recognized the traffic congestion in a periphery of the subject vehicle;
execute the offset control during a driving assistance period in which the subject vehicle travels with the driving assistance control;
end the offset control before the switching from the driving assistance control to the autonomous traveling control when having recognized the driver input during the driving assistance period with the offset control;
request a presentation control device to perform a notification related to automated driving;
request the presentation control device to perform an end notification of the offset control based on recognition of the driver input;
request the presentation control device to perform a shift notification to the autonomous traveling control based on an end of the offset,
wherein
the presentation control device presents information to the driver.

40. A presentation control device that is used for a subject vehicle having an automated driving function and controls presentation of information to a driver, the device comprising:
an offset control recognition unit configured to recognize whether an offset control is executed, wherein the offset control moves a traveling position of the subject vehicle in a left direction or a right direction with respect to a reference position for causing the traveling position in a subject vehicle lane during a period in which the subject vehicle travels along a subject vehicle lane by an automated driving function;
a monitoring obligation recognition unit configured to recognize whether a traveling control executed by the automated driving function requires a periphery monitoring obligation of the driver; and
a notification control unit configured to execute a notification related to the offset control by the automated driving function,
wherein
the notification control unit cancels the notification related to the offset control executed when the periphery monitoring obligation of the driver is required.

41. A presentation control device that is used for a subject vehicle having an automated driving function and controls presentation of information to a driver, the device comprising:
an offset control recognition unit configured to recognize whether an offset control is executed, wherein the offset control moves a traveling position of the subject vehicle in a left direction or a right direction with respect to a reference position in a subject vehicle lane during a period in which the subject vehicle travels along a subject vehicle lane by an automated driving function;
a monitoring obligation recognition unit configured to recognize whether a traveling control executed by the automated driving function requires a periphery monitoring obligation of the driver; and
a notification control unit configured to execute a notification related to the offset control by the automated driving function,
wherein
the notification control unit weakens the notification related to the offset control executed when the periphery monitoring obligation of the driver is required as compared with the notification performed when the periphery monitoring obligation is not required.

42. A non-transitory computer-readable storage medium storing a presentation control program that is used for a subject vehicle having an automated driving function and controls presentation of information to a driver, the program causing at least one processor to:
recognize whether an offset control is executed, wherein the offset control moves a traveling position of the subject vehicle in a left direction or a right direction with respect to a reference position in a subject vehicle lane during a period in which the subject vehicle travels along a subject vehicle lane by an automated driving function;
recognize whether a traveling control executed by the automated driving function requires a periphery monitoring obligation of the driver;
cancel the notification related to the offset control executed when the periphery monitoring obligation of the driver is required.

43. A non-transitory computer-readable storage medium storing a presentation control program that is used for a subject vehicle having an automated driving function and controls presentation of information to a driver, the program causing at least one processor to:
recognize whether an offset control is executed, wherein the offset control moves a traveling position of the subject vehicle in a left direction or a right direction with respect to a reference position in a subject vehicle lane during a period in which the subject vehicle travels along a subject vehicle lane by an automated driving function;
recognize whether a traveling control executed by the automated driving function requires a periphery monitoring obligation of the driver; and
weaken the notification related to the offset control executed when the periphery monitoring obligation of the driver is required as compared with the notification performed when the periphery monitoring obligation is not required.
